(19) United States
(12) Patent Application Publication
(10) Pub. No.: US 2014/0347223 A1
(43) Pub. Date: Nov. 27, 2014

(54) PORTABLE WIRELESS NODE ORIENTATION ADJUSTMENT

(71) Applicant: Elwha LLC, a limited liability corporation of the State of Delaware, Bellevue, WA (US)

(72) Inventors: Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Douglas O. Reudink, Port Townsend, WA (US); Clarence T. Tegreene, Mercer Island, WA (US)

(73) Assignee: Elwha LLC, a limited liability corporation of the State of Delaware, Bellevue, WA (US)

(21) Appl. No.: 13/975,116

(22) Filed: Aug. 23, 2013

Related U.S. Application Data
(63) Continuation-in-part of application No. 13/956,107, filed on Jul. 31, 2013.
Application No. 13/956,107 is a continuation-in-part of application No. 13/945,801, filed on Jul. 18, 2013.
Application No. 13/945,801 is a continuation-in-part of application No. 13/936,921, filed on Jul. 8, 2013.
Application No. 13/936,921 is a continuation-in-part of application No. 13/904,970, filed on May 29, 2013.
Application No. 13/904,970 is a continuation-in-part of application No. 13/902,585, filed on May 24, 2013.

(51) Int. Cl. H01Q 3/00

(52) U.S. Cl. CPC H01Q 3/00
USPC 342/385

(57) ABSTRACT

Disclosed herein are example embodiments for portable wireless node orientation adjustment. For certain example embodiments, at least one device, such as a portable wireless node: (i) may detect a change in an orientation position of a portable wireless node; or (ii) may obtain at least one direction to aim at least one beam toward a counterpart wireless node. However, claimed subject matter is not limited to any particular described embodiments, implementations, examples, or so forth.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

(1) For purposes of the USPTO extra-statutory requirements, the present application constitutes a continuation-in-part of U.S. patent application Ser. No. 13/842,040, entitled “Frequency Accommodation”, naming Roderick A. Hyde, Royce A. Levien, Richard T. Lord, Robert W. Lord, Mark A. Malamud, Douglas O. Reudink, and Clarence T. Tegreene as inventors, filed 15 Mar. 2013 (with Atty. Docket No. SE1-0855-US), which is currently co-pending or is an application of which a currently co-pending application is entitled to the benefit of the filing date.
(2) For purposes of the USPTO extra-statutory requirements, the present application constitutes a continuation-in-part of U.S. patent application Ser. No. 13/902,585, entitled “Facilitating Wireless Communication in Conjunction with Orientation Position”, naming Roderick A. Hyde, Royce A. Levien, Richard T. Lord, Robert W. Lord, Mark A. Malamud, Douglas O. Reudink, and Clarence T. Tegreene as inventors, filed 24 May 2013 (with Atty. Docket No. SE1-0856-US), which is currently co-pending or is an application of which a currently co-pending application is entitled to the benefit of the filing date.
(3) For purposes of the USPTO extra-statutory requirements, the present application constitutes a continuation-in-part of U.S. patent application Ser. No. 13/904,970, entitled “Facilitating Wireless Communication in Conjunction with Orientation Position”, naming Roderick A. Hyde, Royce A. Levien, Richard T. Lord, Robert W. Lord, Mark A. Malamud, Douglas O. Reudink, and Clarence T. Tegreene as inventors, filed 29 May 2013 (with Atty. Docket No. SE1-0857-US), which is currently co-pending or is an application of which a currently co-pending application is entitled to the benefit of the filing date.
(4) For purposes of the USPTO extra-statutory requirements, the present application constitutes a continuation-in-part of U.S. patent application Ser. No. 13/936,921, entitled “Supporting Antenna Assembly Configuration Network Infrastructure”, naming Roderick A. Hyde, Royce A. Levien, Richard T. Lord, Robert W. Lord, Mark A. Malamud, Douglas O. Reudink, and Clarence T. Tegreene as inventors, filed 8 Jul. 2013 (with Atty. Docket No. SE1-0858-US), which is currently co-pending or is an application of which a currently co-pending application is entitled to the benefit of the filing date.
(5) For purposes of the USPTO extra-statutory requirements, the present application constitutes a continuation-in-part of U.S. patent application Ser. No. 13/945,801, entitled “Portable Wireless Node Local Cooperation”, naming Roderick A. Hyde, Royce A. Levien, Richard T. Lord, Robert W. Lord, Mark A. Malamud, Douglas O. Reudink, and Clarence T. Tegreene as inventors, filed 18 Jul. 2013 (with Atty. Docket No. SE1-0859-US), which is currently co-pending or is an application of which a currently co-pending application is entitled to the benefit of the filing date.
(6) For purposes of the USPTO extra-statutory requirements, the present application constitutes a continuation-in-part of U.S. patent application Ser. No. 13/956,107, entitled “Portable Wireless Node Auxiliary Relay”, naming Roderick A. Hyde, Royce A. Levien, Richard T. Lord, Robert W. Lord, Mark A. Malamud, Douglas O. Reudink, and Clarence T. Tegreene as inventors, filed 31 Jul. 2013 (with Atty. Docket No. SE1-0860-US), which is currently co-pending or is an application of which a currently co-pending application is entitled to the benefit of the filing date.

### RELATED APPLICATIONS

(1) U.S. patent application Ser. No. 13/317,338, entitled “Surface Scattering Antennas”, naming Adam Bily, Anna K. Boardman, Russell J. Hannigan, John Hunt, Nathan Kundtz, David R. Nash, Ryan Allan Stevenson, and Philip A. Sullivan as inventors, filed 14 Oct. 2011 (with Docket No. 0209-011-001-000000), is related to the present application.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### BRIEF DESCRIPTION OF THE FIGURES

FIG. 1 is a block diagram indicative of a spatial relationship or interconnectedness of drawing sheets that respectively correspond to FIGS. 1A-1L, which together depict at least an example enviro-system related to certain example embodiments.

FIG. 1A is a schematic diagram of example wireless nodes in accordance with certain example embodiments.

FIGS. 1B-1L are individual schematic diagrams that may be combined to form a joint schematic diagram illustrating example implementations for accommodating one or more different frequencies in a wireless environment in accordance with certain example embodiments.

FIG. 2 is a schematic diagram of an example portable wireless node including one or more example components in accordance with certain example embodiments.

FIG. 3 is a schematic diagram of an example fixed node, such as a fixed wireless node or a fixed wired node, including one or more example components in accordance with certain example embodiments.

FIG. 4A is a schematic diagram that includes at least one example device, such as a portable wireless node, that is capable of handling scenarios for portable wireless node orientation adjustment in accordance with certain example embodiments.

FIGS. 4B-4D are schematic diagrams that include at least one example device and that depict example scenarios for portable wireless node orientation adjustment in accordance with certain example embodiments.

FIG. 5 is a flow diagram illustrating an example method for at least one device with regard to portable wireless node orientation adjustment in accordance with certain example embodiments.

FIGS. 6A-6F depict example additions or alternatives for a flow diagram of FIG. 5 in accordance with certain example embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

For certain example embodiments, one or more wireless communication parameters may be adopted by a mobile device based at least partially on a physical state of a mobile device to strengthen, enhance, improve, or a combination thereof, etc. a communication channel between a mobile device and another wireless device, such as a base station. Additionally or alternatively, a physical state of (e.g., a location of or an orientation of) a mobile device may be altered to strengthen, enhance, improve, or a combination thereof, etc. a communication channel between a mobile device and an another device, such as a base station (e.g., orientation of at least one communicating device may be altered to strengthen, enhance, improve, or a combination thereof, etc. a communication channel between/among one or more wireless devices).

For certain example embodiments, a physical state of a mobile device may include a spatial location of the mobile device or an orientation of the mobile device. For certain example implementations, a spatial location (e.g., which may be merged with or incorporated into or linked to 3-D mapping data, including those of buildings) may be represented with a geographical position of a mobile device (e.g., with regard to a point on the earth) or an elevation of a mobile device (e.g., with regard to a height above the earth). For certain example implementations, an orientation may be represented with (1) Euler angles or rotations or (2) pitch, roll, or yaw in 3-D Euclidean space.

For certain example embodiments, one or more wireless communication parameters, such as one or more antenna assembly configuration parameters, may include, but are not limited to any one or more of the following. First, an antenna element set may be selected from among multiple antenna elements of an antenna array. Second, a particular phase or delay may be applied to each antenna element of a selected set of antenna elements. Third, a particular power may be applied to each antenna element of a selected set of antenna elements. Fourth, a phased array antenna (e.g., which may be formed from multiple antenna elements comprising or including a single dipole) may include multiple antenna elements that are driven with particular signal values. For instance, different elements (e.g., if an element is covered/blocked), phases/delays, power, or a combination thereof, etc. may be applied to input/output connections of a phased array antenna (e.g., to establish or form a beam). Antennas, including but not limited to antenna arrays or phased arrays, may comprise or include or be formed or constructed using meta-materials. Fifth, a frequency of wireless signal(s) coupled to or from an antenna may be adjusted. Sixth, a frequency band or a wireless communication standard that is being employed may be altered, including but not limited to using a different antenna to support a different frequency band or wireless communication standard.

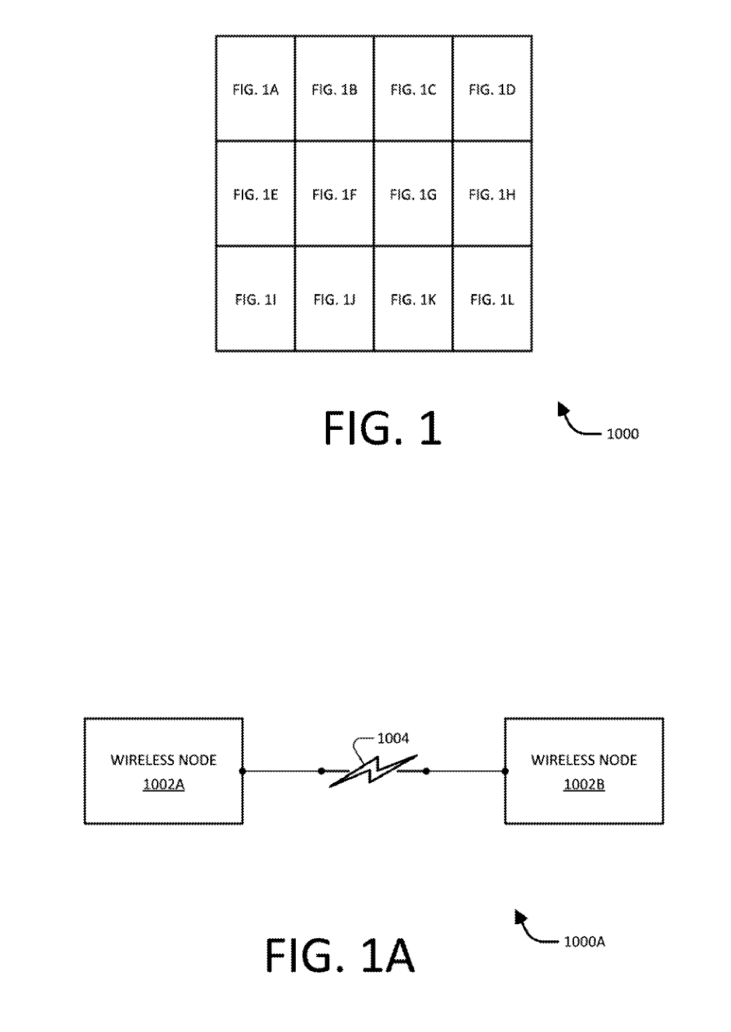

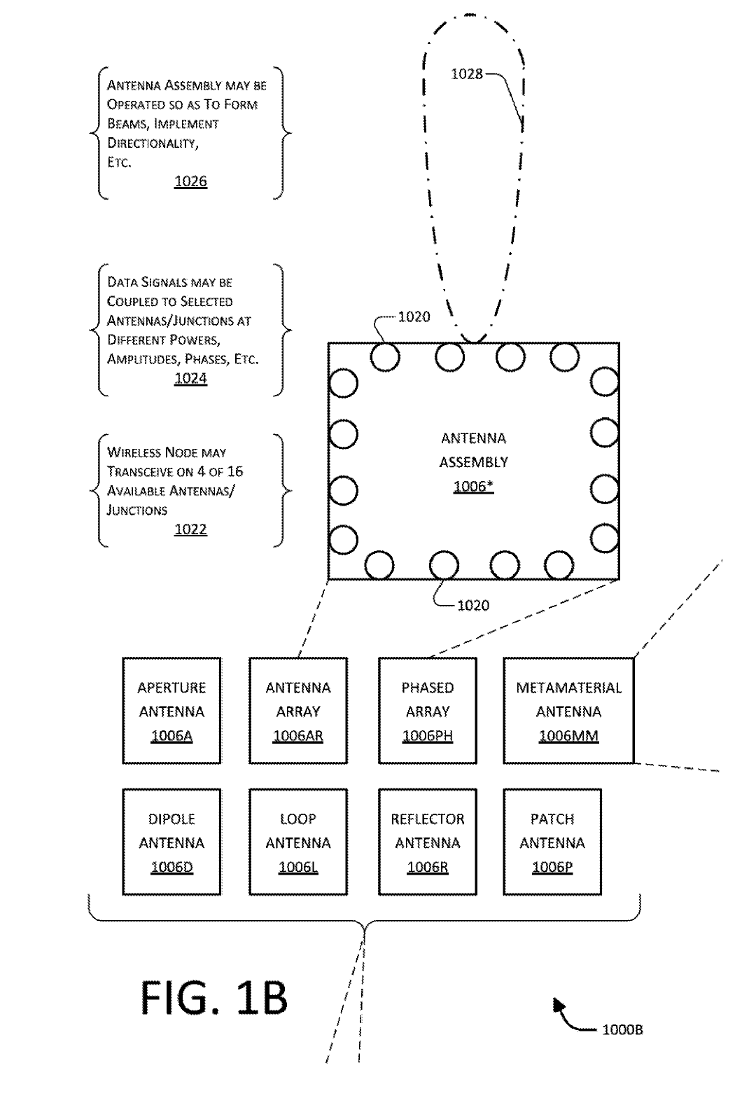

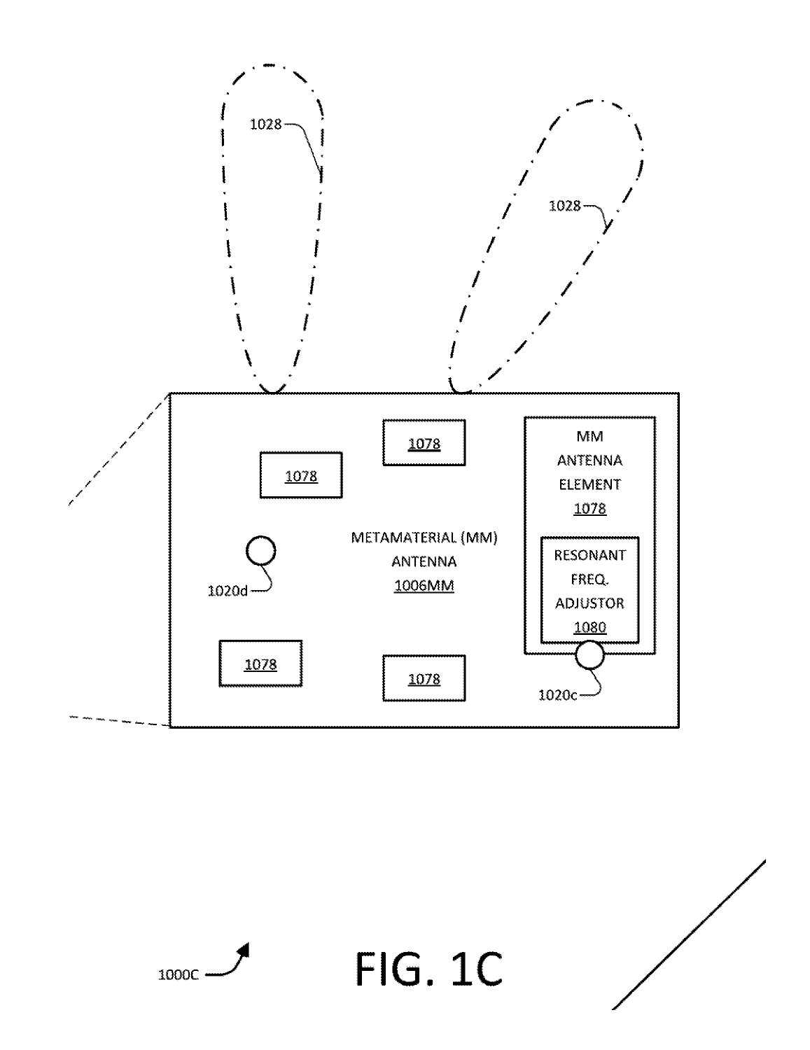

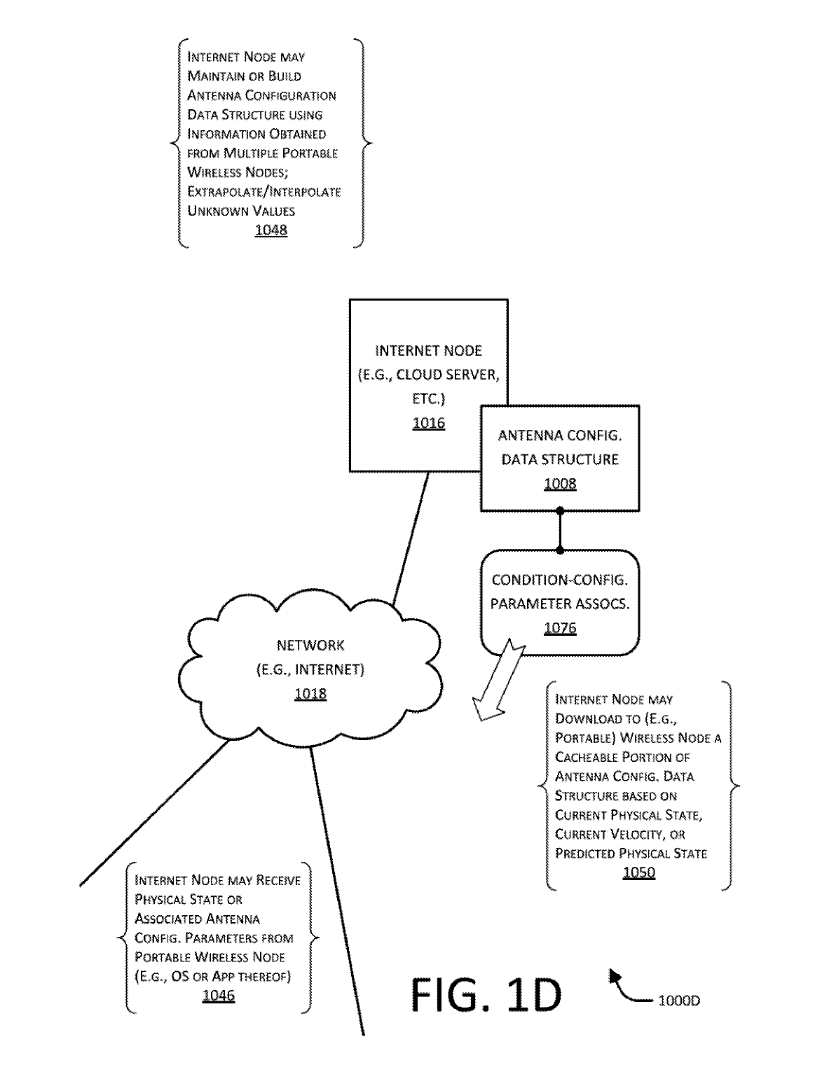

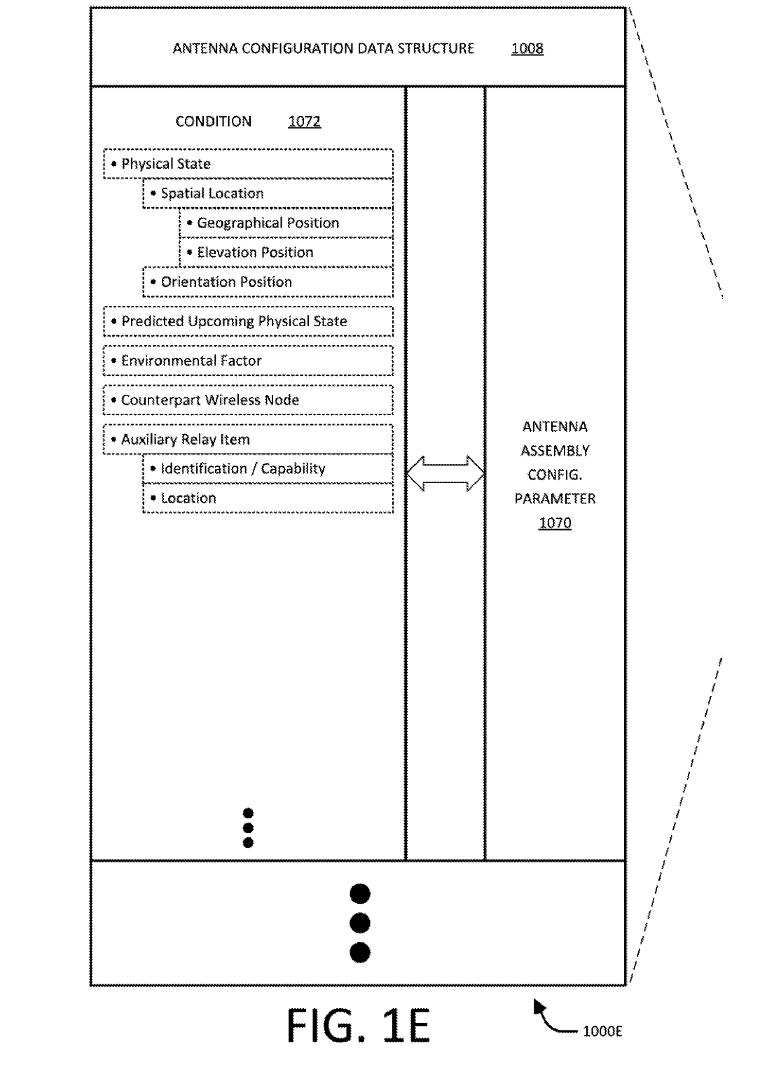

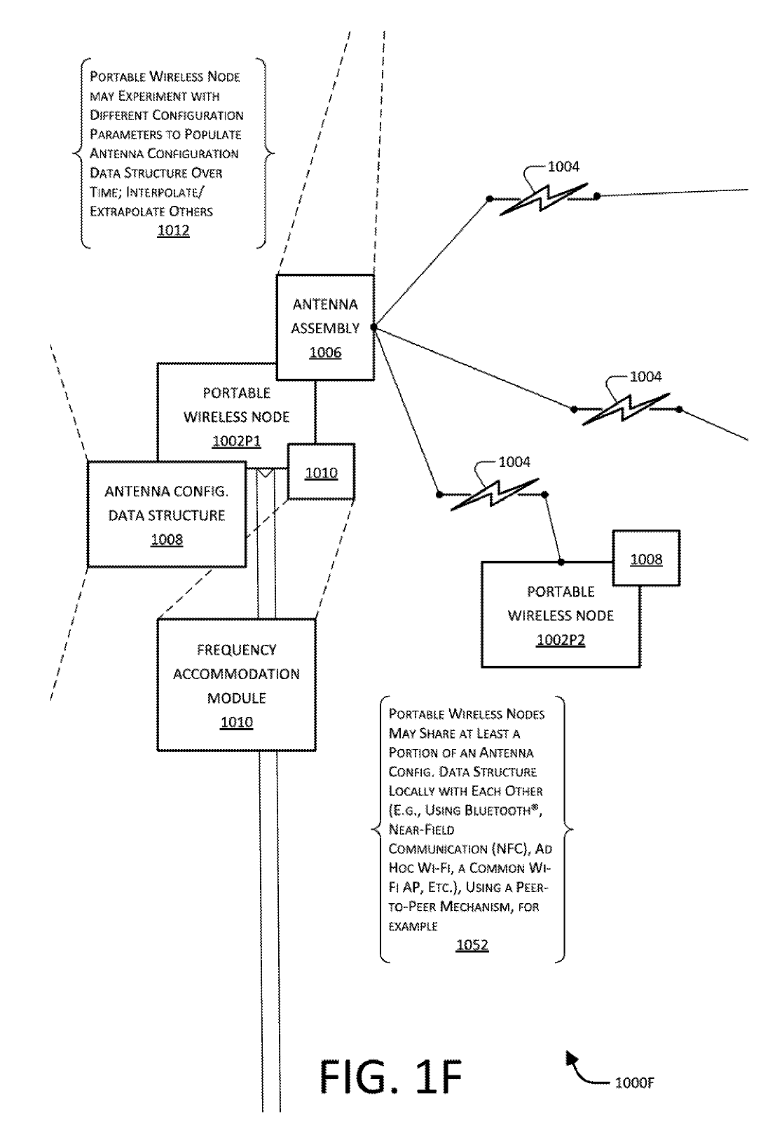

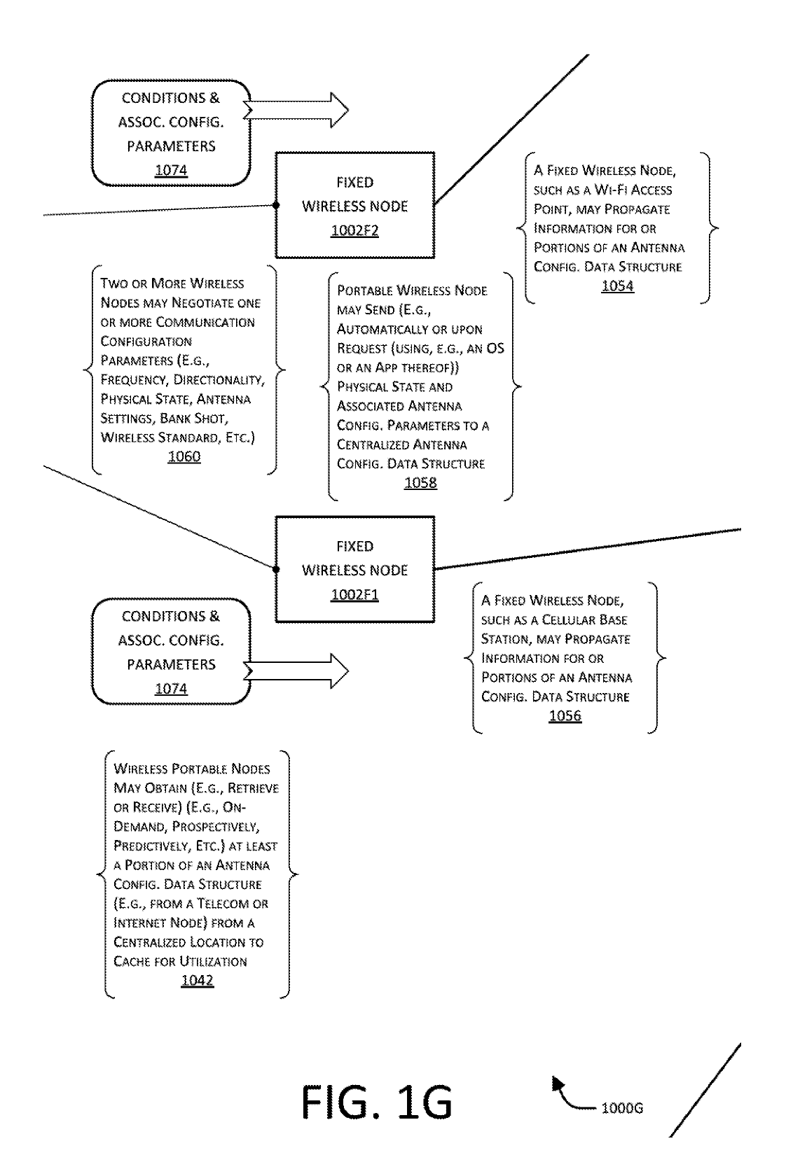

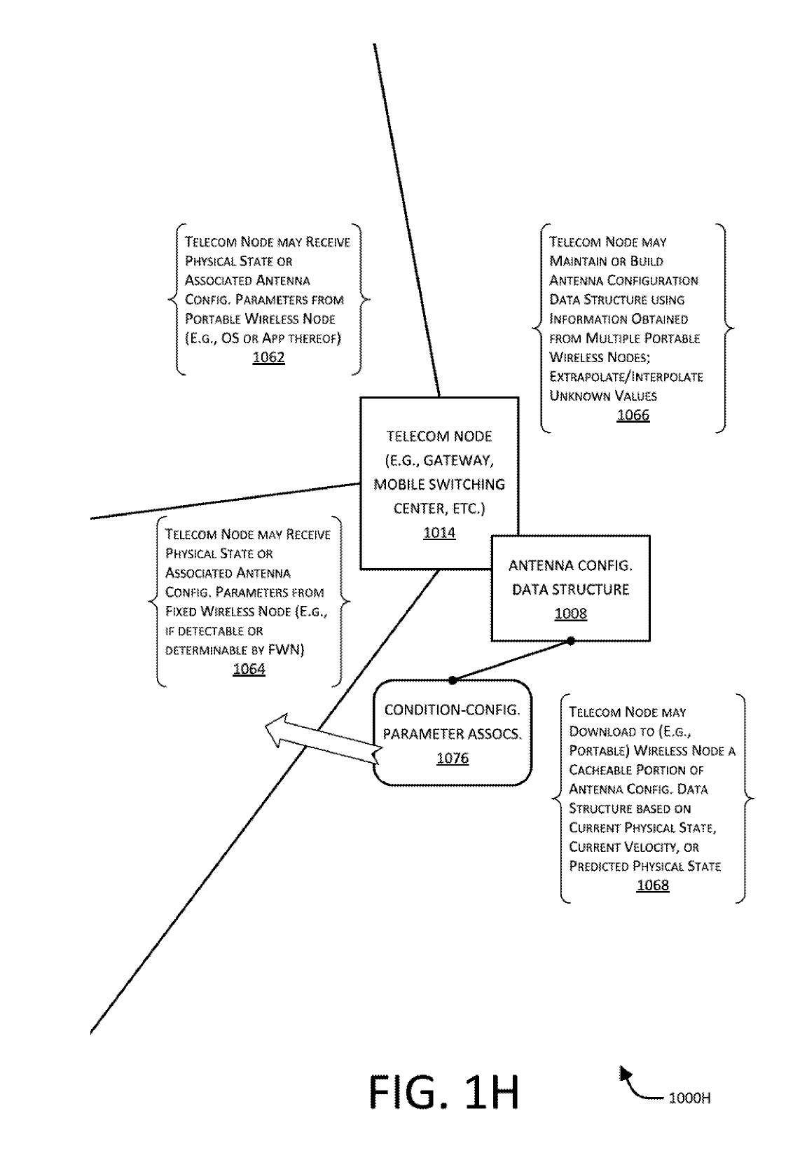

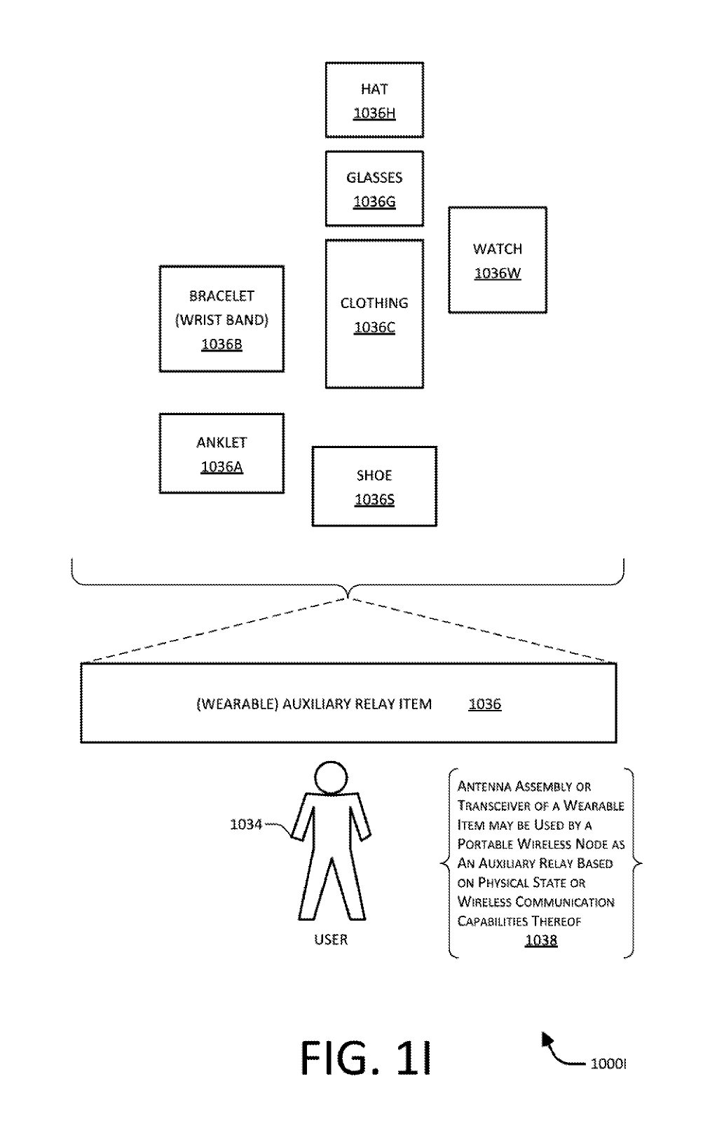

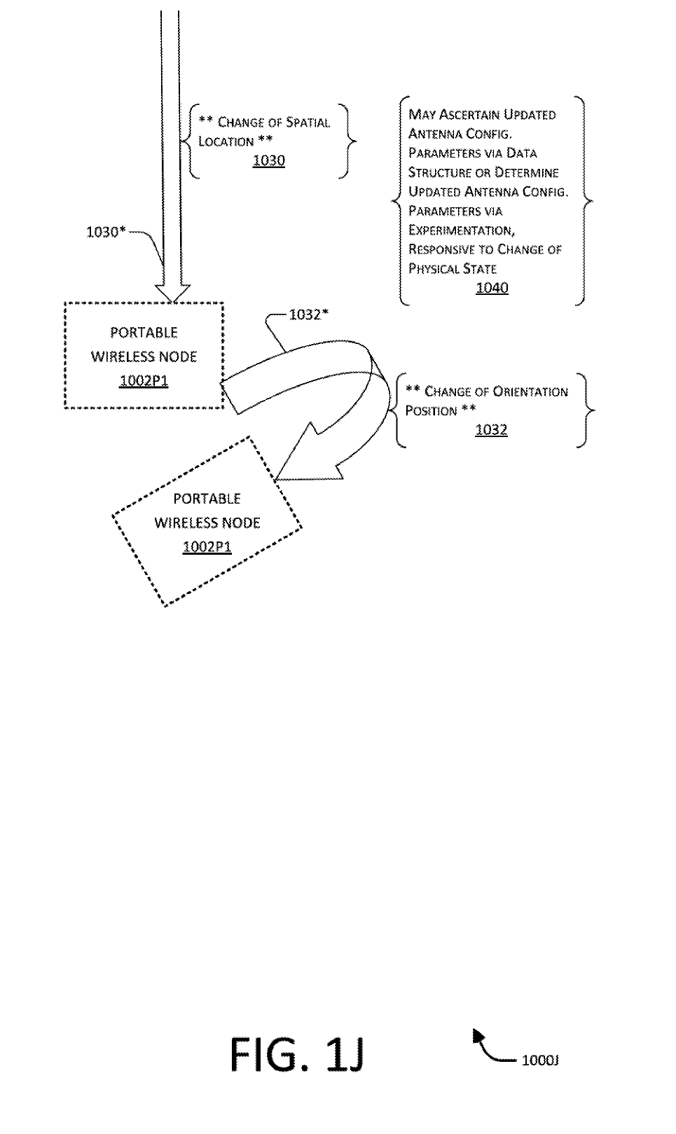

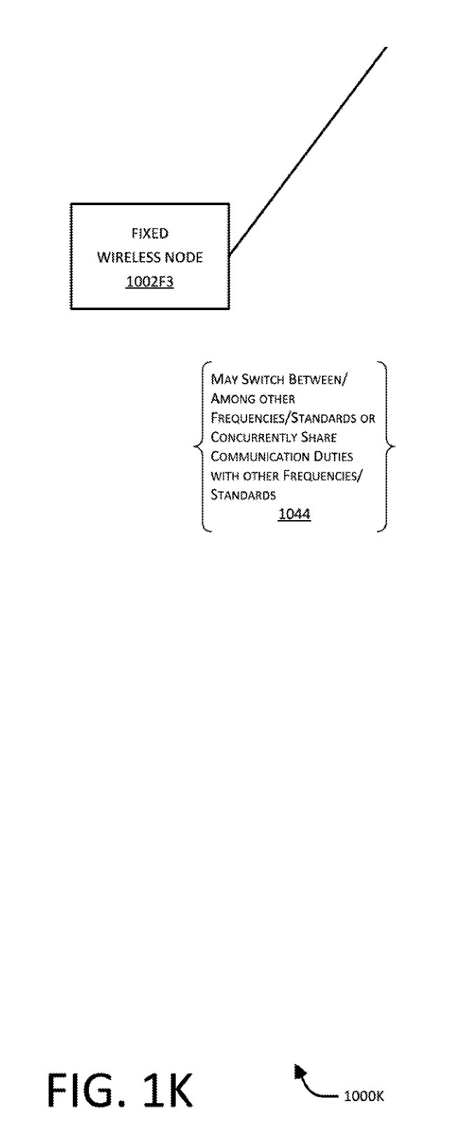

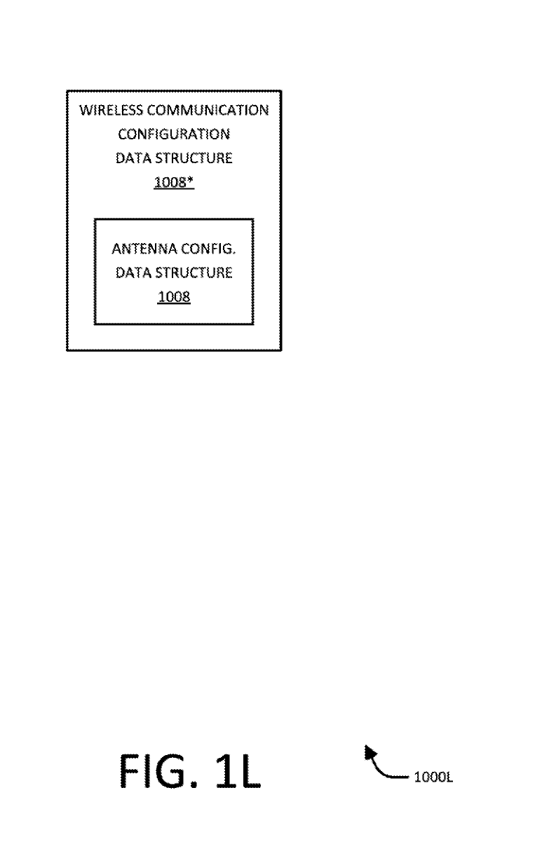

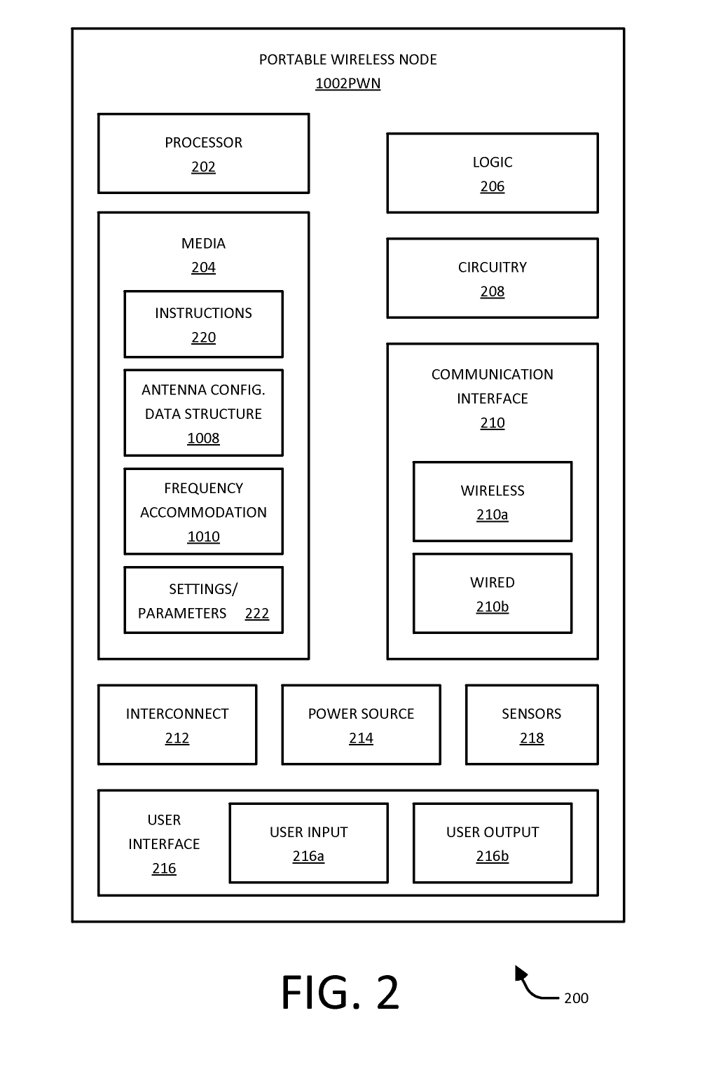

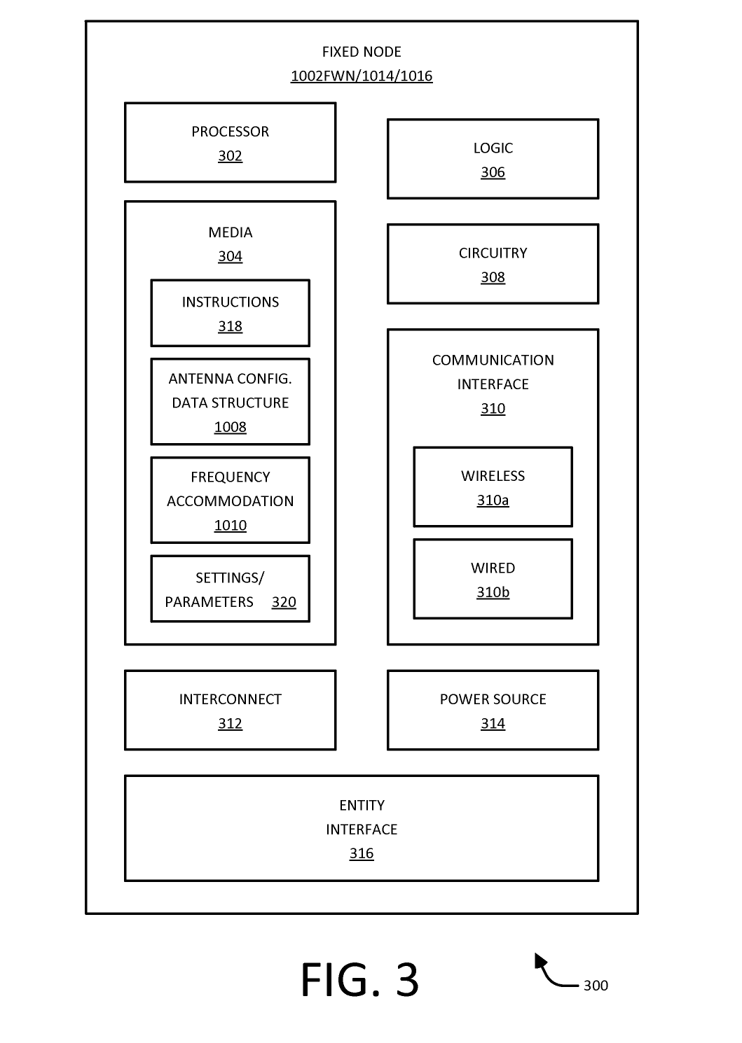

APPLICANT HEREBY INCORPORATES BY REFERENCE HEREIN DESCRIPTION OF AND TEXT ASSOCIATED WITH FIGS. 1-3 (E.G., FIGS. 1, 1A, 1B, 1C, 1D, 1E, 1F, 1G, 1H, 1I, 1J, 1K, 1L, 2, AND 3), INCLUDING BUT NOT LIMITED TO PARAGRAPHS [0017]-[0092] INCLUSIVE IN THEIR ENTIRETY, AT LEAST TO THE EXTENT SUCH SUBJECT MATTER IS NOT INCONSISTENT HEREWITH, OF U.S. patent application Ser. No. 13/842,040, entitled “Frequency Accommodation”, naming Roderick A. Hyde et al. as inventors, filed 15 Mar. 2013 (with Atty. Docket No. SE1-0855-US).

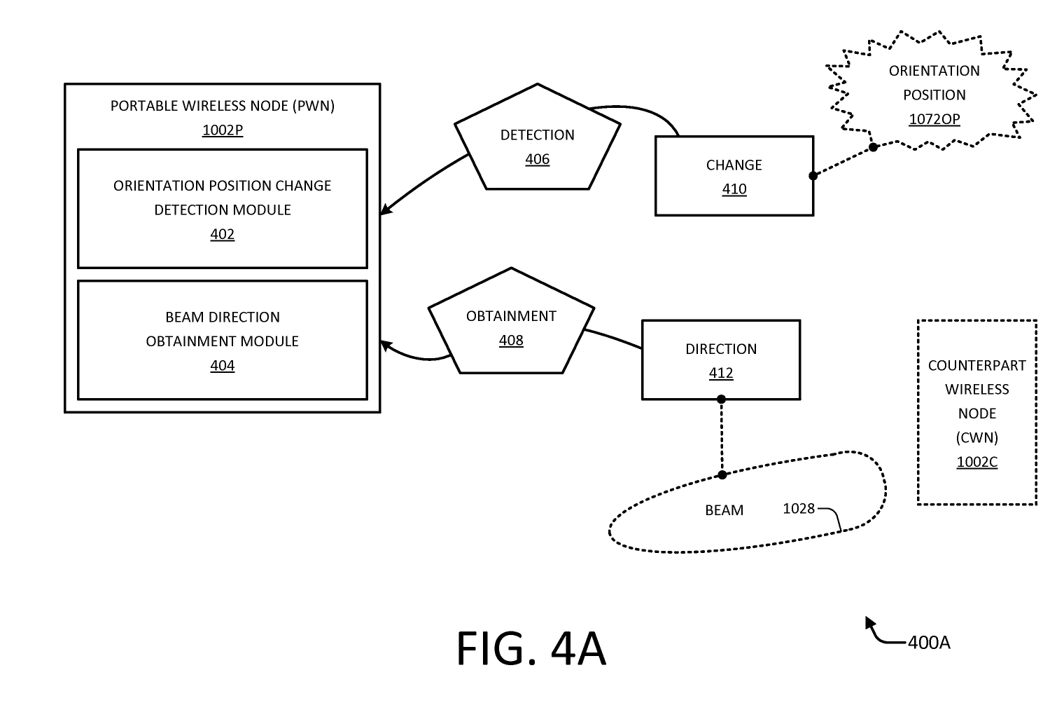

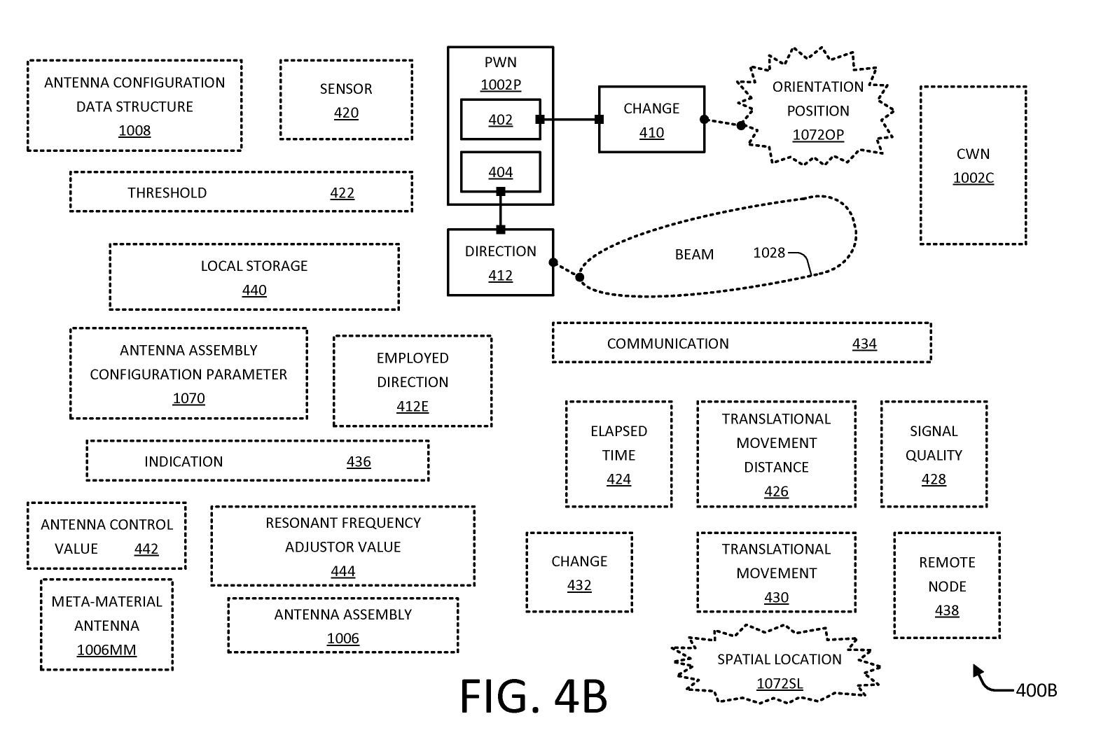

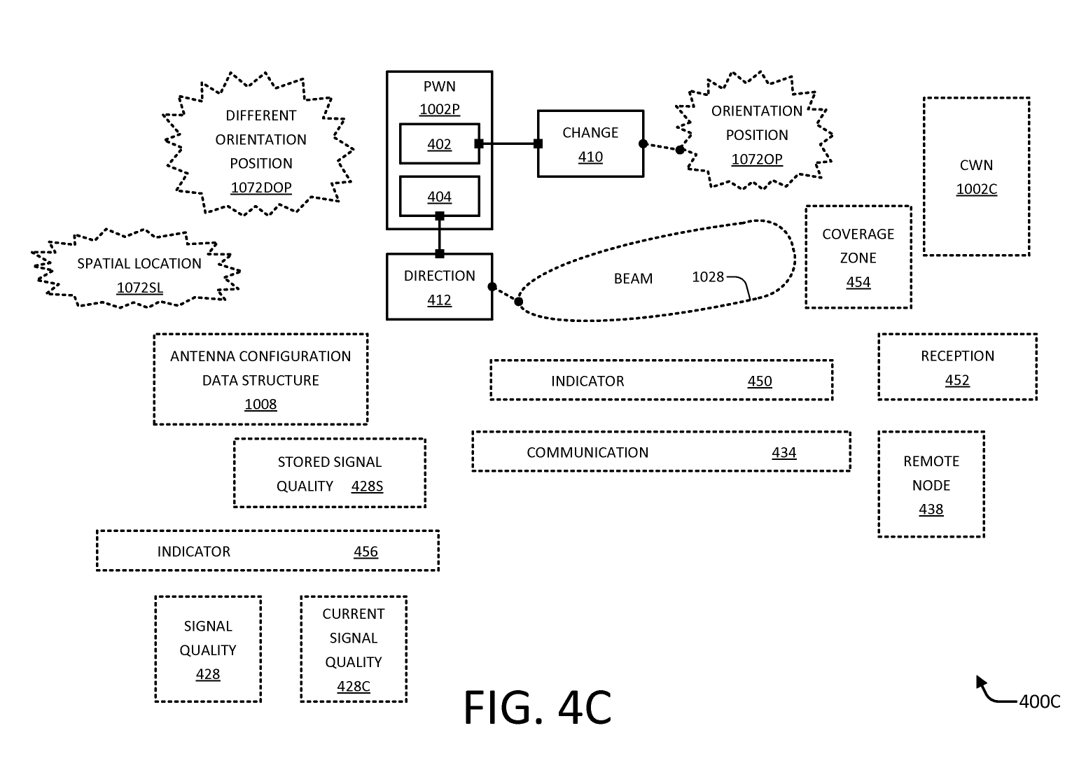

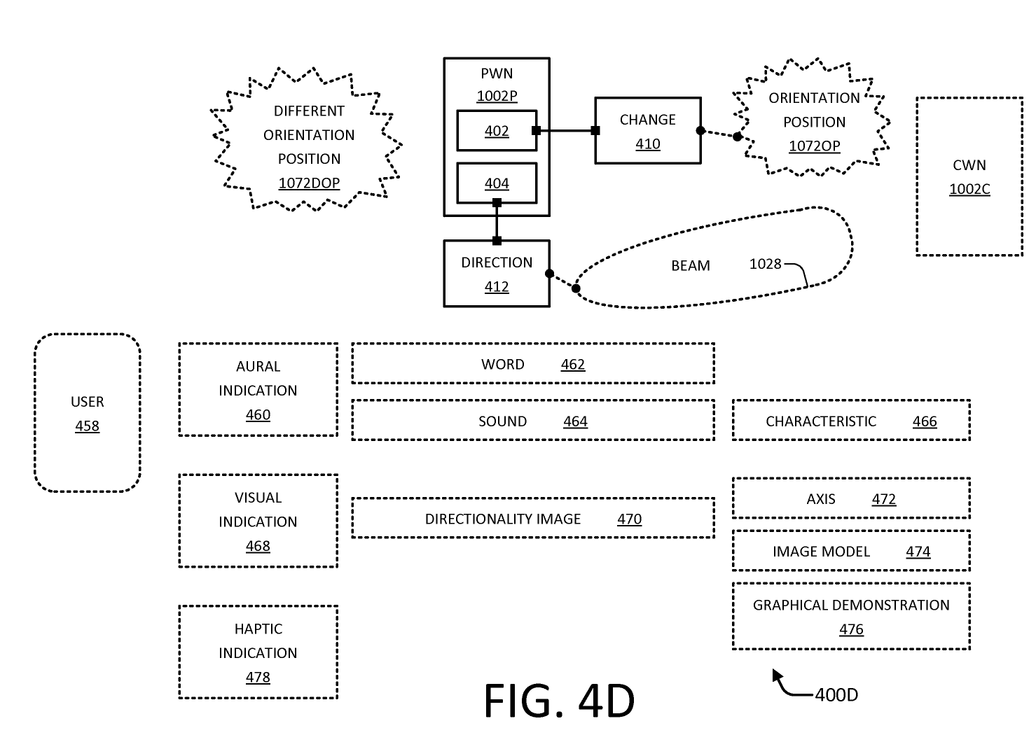

FIG. 4A is a schematic diagram 400A that includes at least one example device, such as a portable wireless node, that is capable of handling scenarios for portable wireless node orientation adjustment in accordance with certain example embodiments. As shown in FIG. 4A, by way of example but not limitation, schematic diagram 400A depicts at least one device that may include or comprise at least one portable wireless node (PWN) 1002P. More specifically, schematic diagram 400A depicts at least one device that may include at least one orientation position change detection module 402 or at least one beam direction obtainment module 404. Additionally or alternatively, schematic diagram 400A may include, by way of example but not limitation, at least one detection 406, at least one obtainment 408, at least one change 410, at least one direction 412, at least one orientation position 1072OP, at least one antenna beam 1028, or at least one counterpart wireless node (CWN) 1002C. By way of example but not limitation, an orientation position change detection module 402 or a beam direction obtainment module 404 may include or comprise or be realized with at least one processor that executes instructions (e.g., sequentially, in parallel, at least partially overlapping in a time-multiplexed fashion, at least partially across multiple cores, or a combination thereof, etc.) as at least one special-purpose computing component, or otherwise as described herein. However, claimed subject matter is not limited to any particular described embodiments, implementations, examples, etc.

For certain example embodiments, an orientation position change detection module 402 or a beam direction obtainment module 404 may be implemented separately or at least partially jointly or in combination with or by at least one portable wireless node 1002P. For certain example implementations, an orientation position change detection module 402 may be configured to detect (e.g., via at least one detection 406) a change 410 in an orientation position 1072OP of a portable wireless node 1002P. For certain example implementations, a beam direction obtainment module 404 may be configured to obtain (e.g., via at least one obtainment 408) at least one direction 412 to aim at least one beam 1028 toward a counterpart wireless node 1002C.

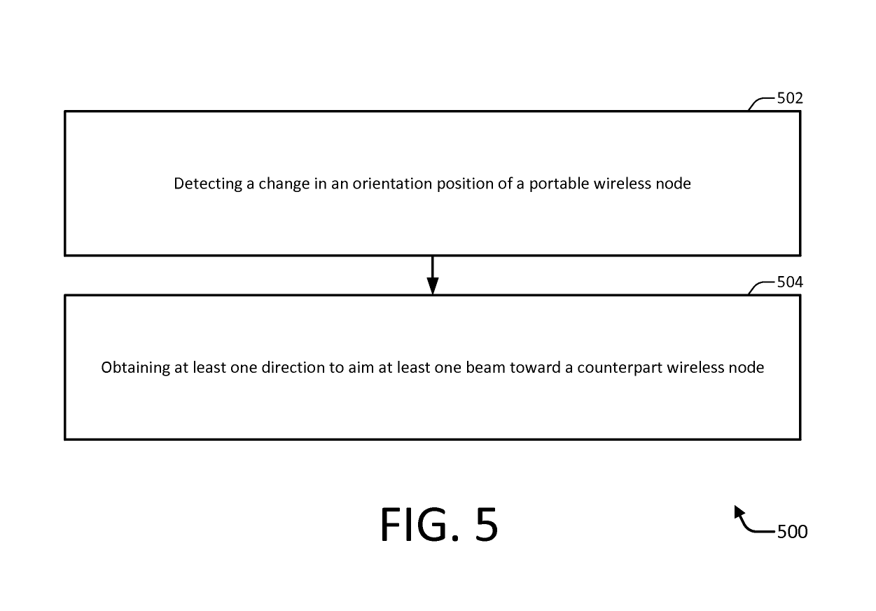

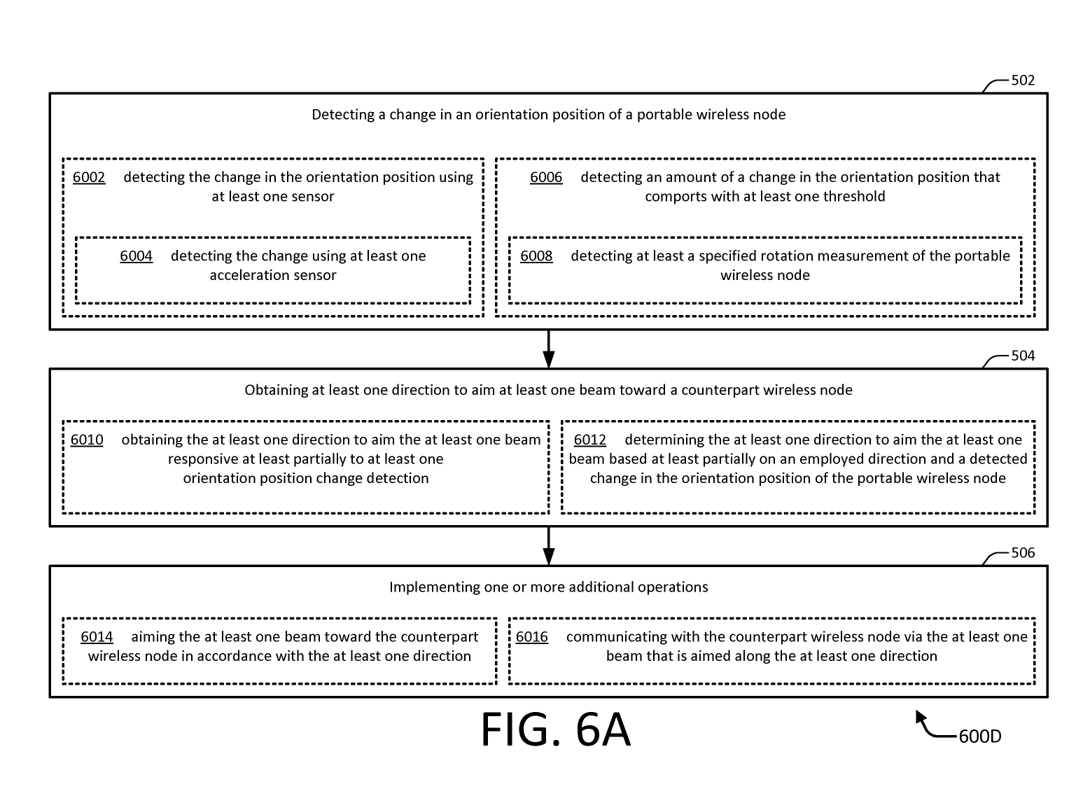

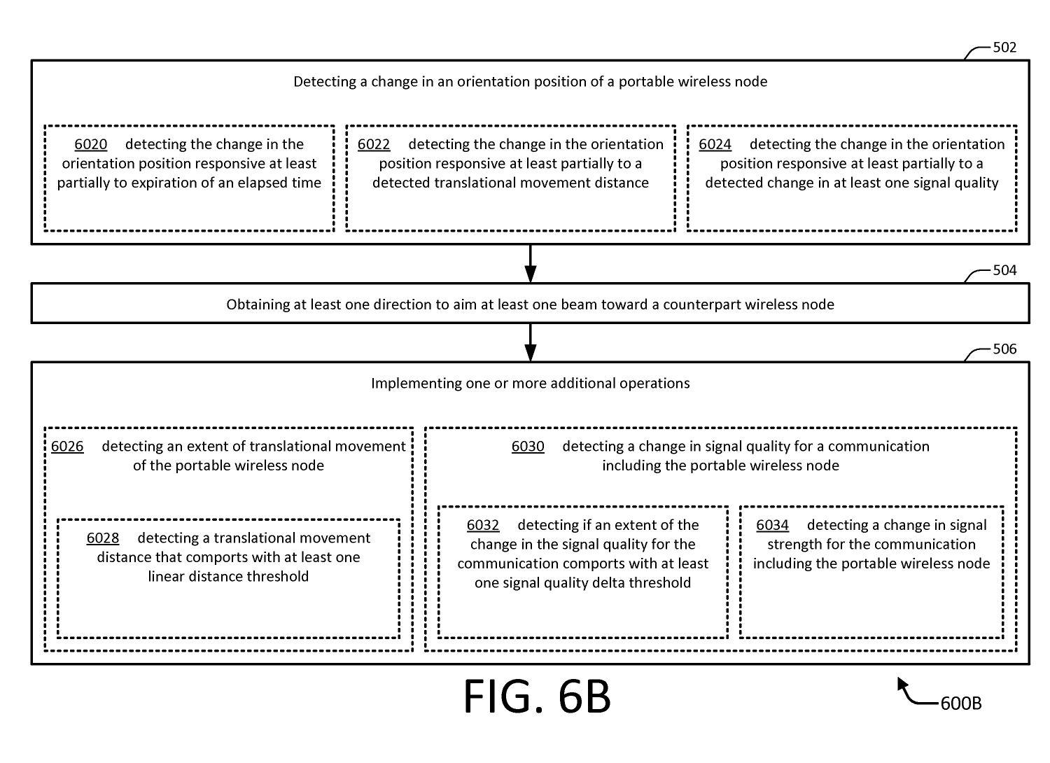

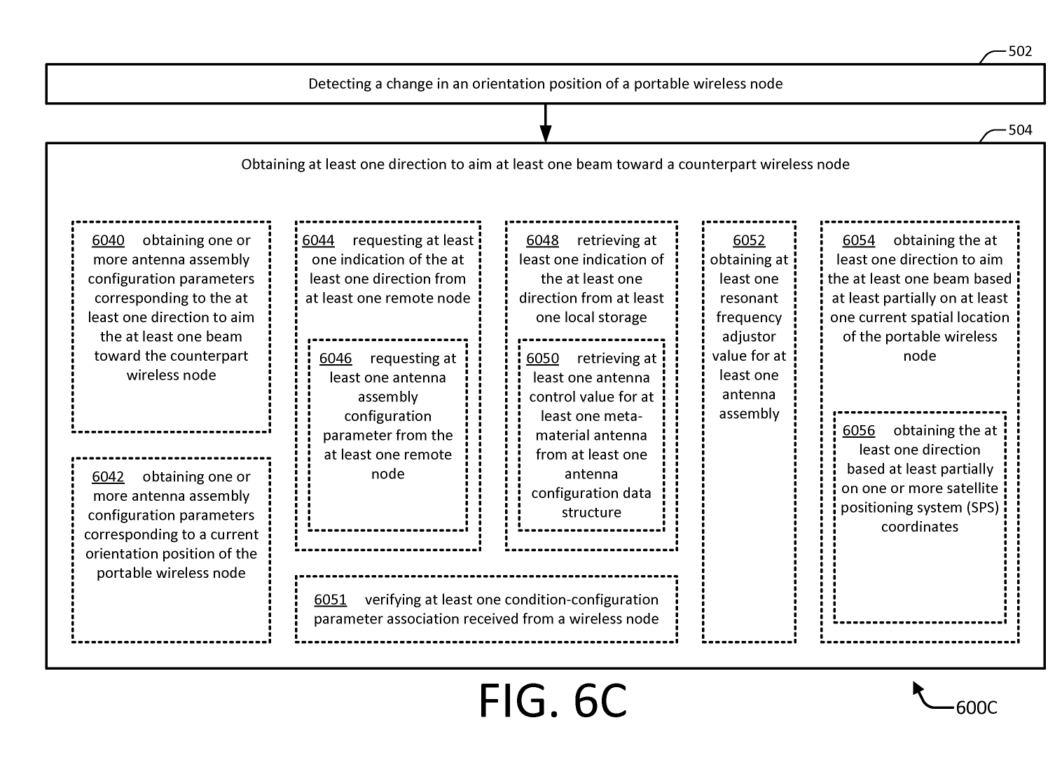

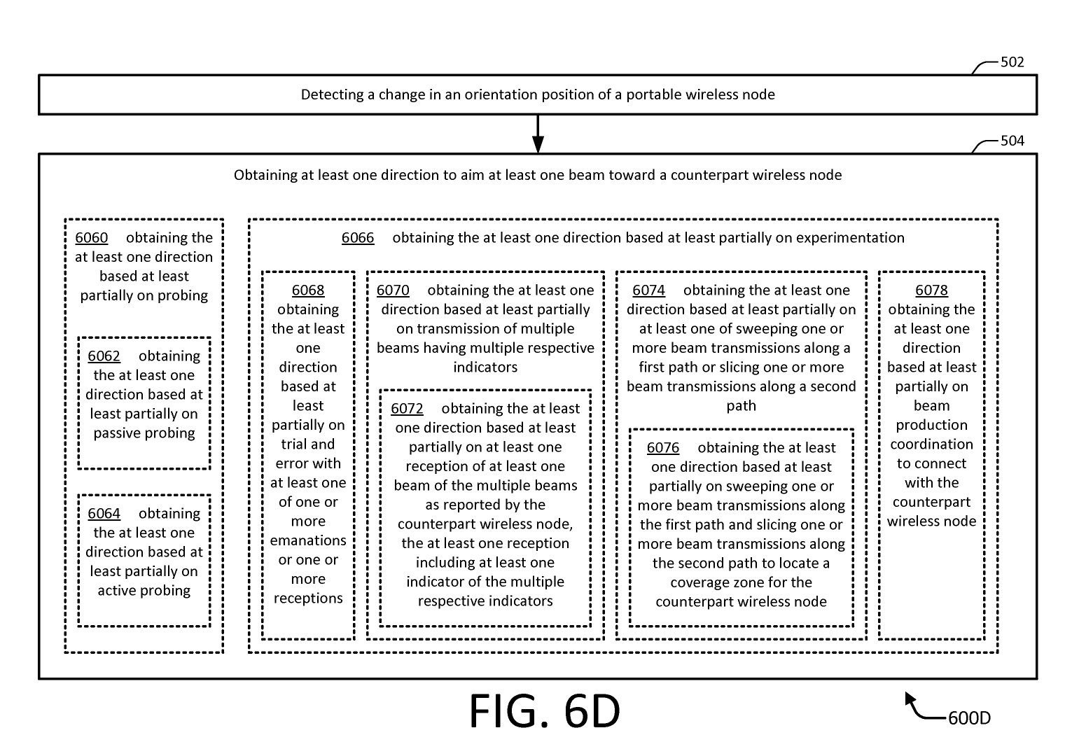

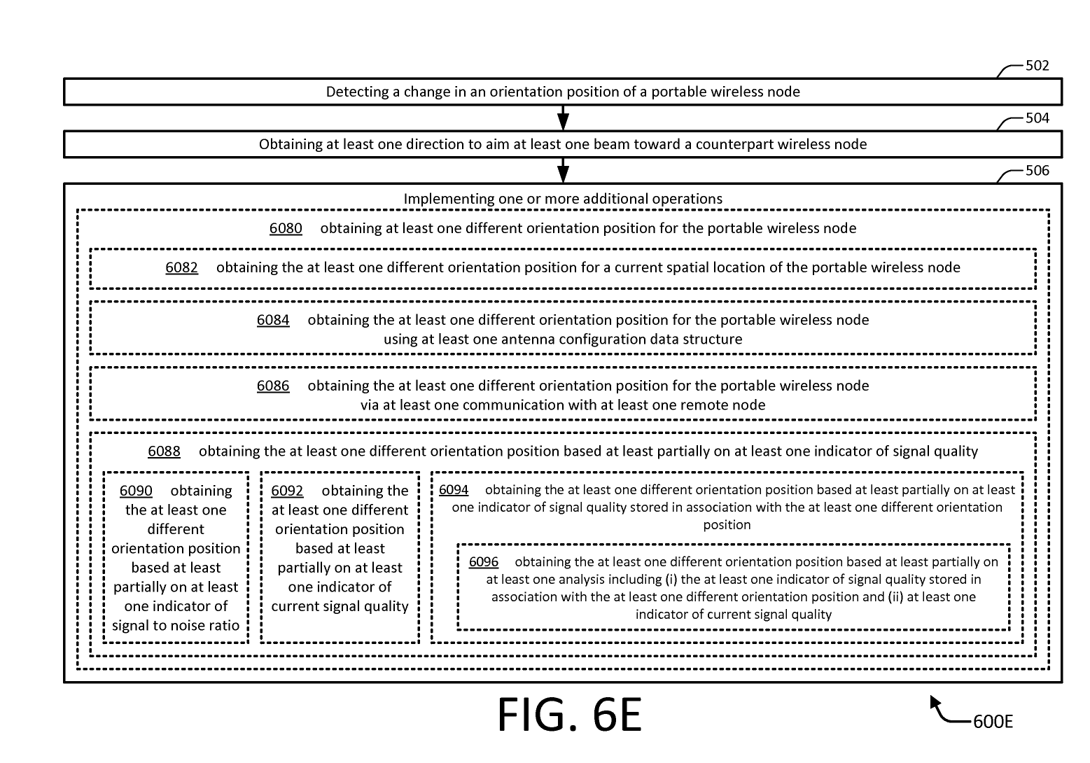

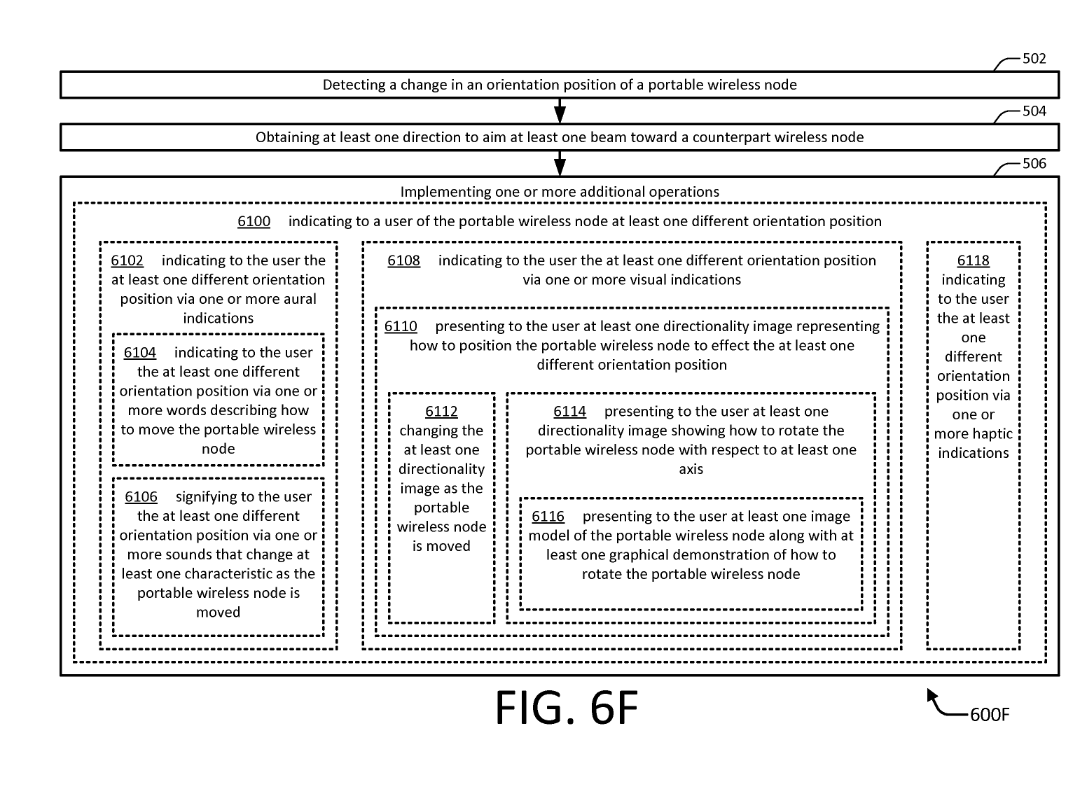

FIGS. 4B-4D are schematic diagrams 400B-400D that include at least one example device and that depict example scenarios for portable wireless node orientation adjustment in accordance with certain example embodiments. As shown in FIGS. 4B-4D, by way of example but not limitation, one or more of schematic diagrams 400B-400D may include at least one portable wireless node (PWN) 1002P, at least one orientation position change detection module 402, at least one beam direction obtainment module 404, at least one change 410, at least one direction 412, at least one orientation position 1072OP, at least one antenna beam 1028, or at least one counterpart wireless node (CWN) 1002C. Each of schematic diagrams 400B-400D may include alternative or additional depictions, which may relate to portable wireless node orientation adjustment, as described herein. In addition to or in alternative to description herein below with specific reference to FIGS. 4B-4D, illustrated aspects of schematic diagrams 400B-400D may be relevant to example description with reference to any one or more of FIG. 5 or 6A-6F. However, claimed subject matter is not limited to any particular described embodiments, implementations, examples, etc.

As shown in FIG. 4B, by way of example but not limitation, schematic diagram 400B may further include at least one sensor 420, at least one threshold 422, at least one employed direction 412E, at least one elapsed time 424, at least one translational movement distance 426, at least one signal quality 428, at least some translational movement 430, at least one change 432, at least one communication 434, at least one antenna assembly configuration parameter 1070, at least one indication 436, at least one remote node 438, at least one local storage 440, at least one antenna control value 442, at least one meta-material antenna 1006MM, at least one antenna configuration data structure 1008, at least one resonant frequency adjustor value 444, at least one antenna assembly 1006, or at least one spatial location 1072SL. Additional or alternative description that may be relevant to schematic diagram 400B is provided herein below with particular reference to one or more of any of FIGS. 6A-6F.

As shown in FIG. 4C, by way of example but not limitation, schematic diagram 400C may further include at least one indicator 450, at least one reception 452, at least one coverage zone 454, at least one different orientation position 1072DOP, at least one spatial location 1072SL, at least one antenna configuration data structure 1008, at least one communication 434, at least one remote node 438, at least one indicator 456, at least one signal quality 428, at least one current signal quality 428C, or at least one stored signal quality 428S. Additional or alternative description that may be relevant to schematic diagram 400C is provided herein below with particular reference to one or more of any of FIGS. 6A-6F.

As shown in FIG. 4D, by way of example but not limitation, schematic diagram 400D may further include at least one different orientation position 1072DOP, at least one user 458, at least one aural indication 460, at least one word 462, at least one sound 464, at least one characteristic 466, at least one visual indication 468, at least one directionality image 470, at least one axis 472, at least one image model 474, at least one graphical demonstration 476, or at least one haptic indication 478. Additional or alternative description that may be relevant to schematic diagram 400D is provided herein below with particular reference to one or more of any of FIGS. 6A-6F.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

FIG. 5 is a flow diagram 500 illustrating an example method for at least one device with regard to portable wireless node orientation adjustment in accordance with certain example embodiments. As illustrated, flow diagram 500 may include any of operations 502-504. Although operations 502-504 are shown or described in a particular order, it should be understood that methods may be performed in alternative manners without departing from claimed subject matter, including, but not limited to, with a different order or number of operations or with a different relationship between or among operations. Also, at least some operation(s) of flow diagram 500 may be performed so as to be fully or partially overlapping with other operation(s). For certain example embodiments, one or more operations of flow diagram 500 may be performed by at least one device, such as a portable wireless node 1002P or at least a portion thereof, such as one or more modules thereof. However, claimed subject matter is not limited to any particular described embodiments, implementations, examples, etc.

For certain example embodiments, a method for portable wireless node orientation adjustment (e.g., that may include, involve, address, react to, pertain to, or a combination thereof, etc. or other otherwise relate to frequency accommodation, such as by detecting an adjustment to an orientation position of a portable wireless node or suggesting an adjustment to an orientation position of a portable wireless node), which method may be at least partially implemented using hardware (e.g., circuitry, at least one processor, processor-accessible memory, at least one module, or a combination thereof, etc.) of a device such as a portable wireless node, may include an operation 502 or an operation 504. An operation 502 may be directed at least partially to detecting a change in an orientation position of a portable wireless node. For certain example implementations, at least one device (e.g., a portable wireless node 1002P, such as a smart phone device) may detect (e.g., discover, ascertain existence of, observe, realize via a sensor, become aware of, discern via analysis, or a combination thereof, etc., such as via at least one detection 406) a change 410 (e.g., an alteration, an adjustment, a modification, a deviation, a shift, a difference, a variation, or a combination thereof, etc.) in an orientation position 1072OP (e.g., a direction that is being faced toward or pointed to, a vector in space—such as a normal to a face or an edge of a device, an Euler value, a roll or pitch or yaw value, a value representing a tilt, a rotational position, an angle of inclination or declination, an equation defining a geometric object—such as a plane—having a determinable relationship to a position of a mobile device—such as lying within or being parallel thereto, or a combination thereof, etc.) of a portable wireless node 1002P (e.g., e.g., a mobile device, a mobile phone, a tablet, a slate computer, a phablet, a portable gaming device, a smartphone, a notebook computer, a mobile repeater, a user equipment (UE), a mobile station (MS), a laptop computer, a hand-held radio, a wireless component for a vehicle, a walker-talkie, a roving transceiver, a wireless device that moves under its own power or control (e.g., an autonomous motorized robot or an unmanned aerial vehicle (UAV)), a wireless device that moves under the power or control of another entity (e.g., a vehicle or a remotely-piloted craft that is controlled by either a passenger or a remote human or by a remote machine), or a combination thereof, etc.).

For certain example embodiments, an operation 504 may be directed at least partially to obtaining at least one direction to aim at least one beam toward a counterpart wireless node. For certain example implementations, at least one device (e.g., a portable wireless node 1002P, such as a tablet computer) may obtain (e.g., acquire, ascertain, determine, receive, retrieve, procure, calculate, or a combination thereof, etc., such as via at least one obtainment 408) at least one direction 412 (e.g., vector away from a device, in an identified emanation angle with respect to or away from a given portion or part of a device, bearing, trajectory, cardinal direction, number of degrees/radians, positioning coordinates, elevation, or a combination thereof, etc.) to aim (e.g., point, position, strive to place, attempt to locate, target, or a combination thereof, etc.) at least one beam 1028 (e.g., focused electromagnetic communication, directed emanation or reception, antenna beam pattern, coverage area for radio frequency (RF) signaling, non-omnidirectional wireless communication, targeted transmission or reception spread, or a combination thereof, etc.) toward a counterpart wireless node 1002C (e.g., a fixed wireless node 1002F such as an access point (AP) or a base station (BS) (e.g., of FIGS. 1A-1L), another portable wireless node 1002P* (not explicitly shown), or a combination thereof, etc.).

FIGS. 6A-6F depict example additions or alternatives for a flow diagram of FIG. 5 in accordance with certain example embodiments. As illustrated, flow diagrams of FIGS. 6A-6F may include any of the illustrated or described operations. Although operations are shown or described in a particular order or with a particular relationship to one or more other operations, it should be understood that methods may be performed in alternative manners without departing from claimed subject matter, including, but not limited to, with a different order or number of operations or with a different relationship between or among operations (e.g., operations that are illustrated as nested blocks are not necessarily subsidiary operations and may instead be performed independently or along with one or more other operations). Also, at least some operation(s) of flow diagrams of FIGS. 6A-6F may be performed so as to be fully or partially overlapping with other operation(s). Moreover, one or more of flow diagrams of FIGS. 6A-6F may illustrate implementation of one or more additional operations as represented by an operation 506 (e.g., if depicted). One or more additional operations of an operation 506 may alternatively be performed independently. For certain example embodiments, one or more operations of flow diagrams 600A-600F (of FIGS. 6A-6F) may be performed by at least one device (e.g., a portable wireless node 1002P or at least a portion thereof, such as one or more modules thereof—or alternatively, by an auxiliary relay item 1036 or at least a portion thereof, such as one or more modules thereof). However, claimed subject matter is not limited to any particular described embodiments, implementations, examples, etc.

FIG. 6A illustrates a flow diagram 600A having any one or more of example operations 6002-6016. For example, an operation 502 may include an operation 6002 of detecting the change in the orientation position using at least one sensor. For instance, at least one portable wireless node (e.g., a portable wireless node 1002P, such as a smart phone) may detect (e.g., discover) a change 410 (e.g., deviation) in an orientation position 1072OP (e.g., an angle of inclination) using at least one sensor 420 (e.g., an accelerometer, a gyroscope, an inertial measurement unit (IMU), a compass, or a combination thereof, etc.).

For example, an operation 6002 may include an operation 6004 of detecting the change using at least one acceleration sensor. For instance, at least one portable wireless node (e.g., a portable wireless node 1002P, such as a tablet computer) may detect (e.g., realize) a change 410 (e.g., a modification) using at least one acceleration sensor (e.g., a Micro-Electro-Mechanical Systems (MEMS) accelerometer, a triaxial accelerometer, an inertial force detector, a gravitational sensor, or a combination thereof, etc.).

For example, an operation 502 may include an operation 6006 of detecting an amount of a change in the orientation position that comports with at least one threshold. For instance, at least one portable wireless node (e.g., a portable wireless node 1002P, such as an Apple iPhone) may detect (e.g., discern via at least one analysis) an amount (e.g., a value, a quantifiable level, a measure, an appreciable quantity, a magnitude, or a combination thereof, etc.) of a change 410 (e.g., a difference) in an orientation position 1072OP (e.g., an angle of declination) that comports with (e.g., meets, is in agreement with, conforms to, is equal to, is greater than, is less than, matches with, or a combination thereof, etc.) at least one threshold 422 (e.g., reference level, stipulated value, minimum or maximum indicator, comparative variable, boundary, or a combination thereof, etc.).

For example, an operation 6006 may include an operation 6008 of detecting at least a specified rotation measurement of the portable wireless node. For instance, at least one portable wireless node (e.g., a portable wireless node 1002P, such as a ground or aerial robot, including but not limited to one that positions itself to provide a strong signal for or with respect to one or more other portable wireless nodes, potentially while avoiding human proximity or traffic patterns thereof, and returns to a base for charging when convenient or in accordance with battery constraints) may detect (e.g., become aware of) at least a specified rotation measurement (e.g., at least one Euler value, a number of degrees or radians, an angle between a reference line—such as due north or the horizon or a “previous” orientation—and a “current” orientation, or a combination thereof, etc.) of a portable wireless node 1002P (e.g., a smart phone).

For example, an operation 504 may include an operation 6010 of obtaining the at least one direction to aim the at least one beam responsive at least partially to at least one orientation position change detection. For instance, at least one portable wireless node (e.g., a portable wireless node 1002P, such as a tablet computer) may obtain (e.g., acquire) at least one direction 412 (e.g., a vector away from a device) to aim (e.g., position) at least one beam 1028 responsive (e.g., as a result of, as a consequence of, in dependence upon, in support of, in reaction to, or a combination thereof, etc.) at least partially to at least one orientation position change detection (e.g., a discovery of an inclination deviation, a realization of a rotational adjustment, a sensor value shift that reflects at least one increased value, or a combination thereof, etc.).

For example, an operation 504 may include an operation 6012 of determining the at least one direction to aim the at least one beam based at least partially on an employed direction and a detected change in the orientation position of the portable wireless node. For instance, at least one portable wireless node (e.g., a portable wireless node 1002P, such as a Samsung Galaxy Tab tablet) may determine (e.g., ascertain, calculate, conclude based on data, modify a vector, or a combination thereof, etc.) at least one direction 412 (e.g., trajectory) based at least partially on an employed direction 412E (e.g., a current direction, a previous direction, a direction that is being or was used to transceiver with an antenna beam, or a combination thereof, etc.) and a detected change (e.g., a change 410, such as 35 degrees downward and 12 degrees rightward, that has been sensed).

For example, an operation 506 may include an operation 6014 of aiming the at least one beam toward the counterpart wireless node in accordance with the at least one direction. For instance, at least one portable wireless node (e.g., a portable wireless node 1002P, such as a Nokia Lumia) may aim (e.g., point) at least one beam 1028 (e.g., directed energy emanation) toward a counterpart wireless node 1002C (e.g., a tablet computer) in accordance with at least one direction 412 (e.g., first and second degrees for first and second dimensions, respectively, to turn an antenna beam from pointing toward one position to pointing toward another position).

For example, an operation 506 may include an operation 6016 of communicating with the counterpart wireless node via the at least one beam that is aimed along the at least one direction. For instance, at least one portable wireless node (e.g., a portable wireless node 1002P, such as a smart phone) may communicate (e.g., impart, transmit, receive, exchange, broadcast, accept delivery, send, or a combination, thereof, etc. information, data, knowledge, packets, bits, chips, or a combination thereof, etc.) with a counterpart wireless node 1002C (e.g., a cable modem/wireless router) via at least one beam 1028 (e.g., coverage area for radio frequency (RF) signaling) that is aimed (e.g., strived to place) along at least one direction 412 (e.g., a bearing with respect to a portable wireless node or a general reference point, such as magnetic north).

FIG. 6B illustrates a flow diagram 600B having any one or more of example operations 6020-6034. For example, an operation 502 may include an operation 6020 of detecting the change in the orientation position responsive at least partially to expiration of an elapsed time. For instance, at least one portable wireless node (e.g., a portable wireless node 1002P, such as a tablet computer) may detect (e.g., ascertain existence of) a change 410 (e.g., a shift) in an orientation position 1072OP (e.g., a direction that is being faced toward or pointed to) responsive (e.g., as a result of, as a consequence of, in dependence upon, in support of, in reaction to, or a combination thereof, etc.) at least partially to expiration (e.g., completion, ending, termination, totaling, incrementing up to or down to, or a combination thereof, etc.) of an elapsed time 424 (e.g., a timer, a number of microseconds or minutes, an appointed time in the future, or a combination thereof, etc. at which orientation position may be updated).

For example, an operation 502 may include an operation 6022 of detecting the change in the orientation position responsive at least partially to a detected translational movement distance. For instance, at least one portable wireless node (e.g., a portable wireless node 1002P, such as an Apple iPhone) may detect (e.g., discern via analysis) a change 410 (e.g., an alteration) in an orientation position 1072OP (e.g., a vector in space—such as a normal to a face or a line parallel to an edge of a device) responsive (e.g., as a result of, as a consequence of, in dependence upon, in support of, in reaction to, or a combination thereof, etc.) at least partially to a detected (e.g., discovered, observed, realized via at least one sensor, or a combination thereof, etc.) translational movement distance 426 (e.g., physical relocation length, linear measurement, amount change of spatial location—such as geospatial position or elevation position, IMU readings indicating translocation, difference between spatial positioning system (SPS) coordinates, or a combination thereof, etc. upon detection of which orientation position may be updated).

For example, an operation 502 may include an operation 6024 of detecting the change in the orientation position responsive at least partially to a detected change in at least one signal quality. For instance, at least one portable wireless node (e.g., a portable wireless node 1002P, such as a smart phone) may detect (e.g., discern via an analysis) a change 410 (e.g., a variation) in an orientation position 1072OP (e.g., a roll or a pitch or a yaw value) responsive (e.g., as a result of, as a consequence of, in dependence upon, in support of, in reaction to, or a combination thereof, etc.) at least partially to a detected (e.g., discovered) change 432 (e.g., a variation, a shift, a difference, a deviation, a reduction, an improvement, or a combination thereof, etc.) in at least one signal quality 428 (e.g., received signal strength indicator (RSSI), signal-to-noise ratio (SNR), bit error rate (BER), latency, average or peak bandwidth, transmission power, or a combination thereof, etc.).

For example, an operation 506 may include an operation 6026 of detecting an extent of translational movement of the portable wireless node. For instance, at least one portable wireless node (e.g., a portable wireless node 1002P, such as a Samsung Galaxy phone) may detect (e.g., ascertain) an extent of (e.g., a length of, a distance of, a period of time during which there is occurrence of, an area covered by, a size of, or a combination thereof, etc.) of translational movement 430 (e.g., physical relocation, change of spatial location—such as geospatial position or elevation position, IMU readings indicating translocation, different spatial positioning system (SPS) coordinates, change of location of set of points a specified linear distance, or a combination thereof, etc.) of a portable wireless node 1002P (e.g., a Samsung Galaxy phone).

For example, an operation 6026 may include an operation 6028 of detecting a translational movement distance that comports with at least one linear distance threshold. For instance, at least one portable wireless node (e.g., a portable wireless node 1002P, such as an Amazon Kindle Fire) may detect (e.g., realize via at least one sensor) a translational movement distance 426 (e.g., physical relocation length, linear measurement, amount change of spatial location—such as geospatial position or elevation position, IMU readings indicating translocation, difference between spatial positioning system (SPS) coordinates, or a combination thereof, etc.) that comports with (e.g., meets, is in agreement with, conforms to, is equal to, is greater than, is less than, matches with, or a combination thereof, etc.) at least one linear distance (e.g., one-dimensional unit between two points, length, millimeters, feet, or a combination thereof, etc.) threshold 422 (e.g., reference level, stipulated value, minimum or maximum indicator, comparative variable, boundary, or a combination thereof, etc.).

For example, an operation 506 may include an operation 6030 of detecting a change in signal quality for a communication including the portable wireless node. For instance, at least one portable wireless node (e.g., a portable wireless node 1002P, such as a tablet computer) may detect (e.g., observe) a change 432 (e.g., a variation, a shift, a difference, a deviation, a reduction, an improvement, or a combination thereof, etc.) in signal quality 428 (e.g., received signal strength indicator (RSSI), signal-to-noise ratio (SNR), bit error rate (BER), latency, average or peak bandwidth, transmission power, or a combination thereof, etc.) for a communication 434 (e.g., transmission, reception, exchange of packets, broadcasting, delivery of data, or a combination thereof, etc.) including a portable wireless node 1002P (e.g., a tablet computer).

For example, an operation 6030 may include an operation 6032 of detecting if an extent of the change in the signal quality for the communication comports with at least one signal quality delta threshold. For instance, at least one portable wireless node (e.g., a portable wireless node 1002P, such as an Apple iPad) may detect (e.g., discern via at least one analysis) if an extent of (e.g., a measure of, a size of, a recurrence frequency of, a period of time of an episode of, or a combination thereof, etc.) a change 432 (e.g., a variation, a shift, a difference, a deviation, a reduction, an improvement, or a combination thereof, etc.) in a signal quality 428 (e.g., received signal strength indicator (RSSI), signal-to-noise ratio (SNR), bit error rate (BER), latency, average or peak bandwidth, transmission power, or a combination thereof, etc.) for a communication 434 (e.g., transmission, reception, exchange of packets, broadcasting, delivery of data, or a combination thereof, etc.) comports with (e.g., meets, is in agreement with, conforms to, is equal to, is greater than, is less than, matches with, or a combination thereof, etc.) at least one signal quality delta (e.g., differential, variation, deviation, or a combination thereof, etc. of a signal quality 428) threshold 422 (e.g., reference level, stipulated value, minimum or maximum indicator, comparative variable, boundary, or a combination thereof, etc.).

For example, an operation 6030 may include an operation 6034 of detecting a change in signal strength for the communication including the portable wireless node. For instance, at least one portable wireless node (e.g., a portable wireless node 1002P, such as a smart phone) may detect (e.g., ascertain existence of) a change 432 (e.g., a variation, a shift, a difference, a deviation, a reduction, an improvement, or a combination thereof, etc.) in signal strength (e.g., received signal strength, signal-to-noise ratio, magnitude of electric field at antenna, decibel-volts per meter, or a combination thereof, etc.) for a communication 434 (e.g., transmission, reception, exchange of packets, broadcasting, delivery of data, or a combination thereof, etc.) including a portable wireless node 1002P (e.g., a smart phone).

FIG. 6C illustrates a flow diagram 600C having any one or more of example operations 6040-6056. For example, an operation 504 may include an operation 6040 of obtaining one or more antenna assembly configuration parameters corresponding to the at least one direction to aim the at least one beam toward the counterpart wireless node. For instance, at least one portable wireless node (e.g., a portable wireless node 1002P, such as an LG G2 or successor smart phone) may obtain (e.g., acquire) one or more antenna assembly configuration parameters 1070 (e.g., at least one variable impacting functionality of an antenna assembly or electromagnetic radiation emanating therefrom or collecting thereby, at least one mechanism affecting antenna assembly performance, at least one value applied to an antenna assembly control or data input, at least one boundary or guideline for how electromagnetic fields are to interact with an adjustable antenna assembly, at least one description of how to manipulate signals being forwarded to or accepted from an antenna assembly, at least one indication of a direction to point an antenna beam, at least one indication of a pattern in which to form an antenna beam, one or more phase delays, meta-material antenna control signal values, phased-array antenna operational inputs, antenna element or junction selection indicators, or a combination thereof, etc.) corresponding to (e.g., being matched to, being analogous to, being equivalent to, being related to, being linkable to, or a combination thereof, etc.) at least one direction 412 (e.g., positioning coordinates of a wireless signal target) to aim (e.g., target) at least one beam 1028 (e.g., focused electromagnetic signal) toward a counterpart wireless node (e.g., a Verizon base station).

For example, an operation 504 may include an operation 6042 of obtaining one or more antenna assembly configuration parameters corresponding to a current orientation position of the portable wireless node. For instance, at least one portable wireless node (e.g., a portable wireless node 1002P, such as a Dell laptop) may obtain (e.g., procure) one or more antenna assembly configuration parameters 1070 (e.g., at least one variable impacting functionality of an antenna assembly or electromagnetic radiation emanating therefrom or collecting thereby, at least one mechanism affecting antenna assembly performance, at least one value applied to an antenna assembly control or data input, at least one boundary or guideline for how electromagnetic fields are to interact with an adjustable antenna assembly, at least one description of how to manipulate signals being forwarded to or accepted from an antenna assembly, at least one indication of a direction to point an antenna beam, at least one indication of a pattern in which to form an antenna beam, one or more phase delays, meta-material antenna control signal values, phased-array antenna operational inputs, antenna element or junction selection indicators, or a combination thereof, etc.) corresponding to (e.g., being matched to, being analogous to, being equivalent to, being related to, being linkable to, or a combination thereof, etc.) a current (e.g., present, actual after a previous change, existing, most-recently measured, or a combination thereof, etc.) orientation position 1072OP (e.g., a value representing a tilted angle of screen and a number of degrees a back edge is from true North or another reference line or direction) of a portable wireless node 1002P (e.g., a Dell laptop).

For example, an operation 504 may include an operation 6044 of requesting at least one indication of the at least one direction from at least one remote node. For instance, at least one portable wireless node (e.g., a portable wireless node 1002P, such as a smart phone) may request (e.g., ask for, petition, interrogate for, send message to prompt response including, entreat to receive, or a combination thereof, etc.) at least one indication 436 (e.g., a description, a designation, an expression, a representation, an indirect identification, a direct identification, a reference, a code providing a linkage to, a signal, a value, or a combination thereof, etc.) of at least one direction 412 (e.g., position coordinates of a proximate, line-of-sight base station) from at least one remote node 438 (e.g., a telecommunications node 1014 (e.g., of FIG. 1H), an internet node 1016 (e.g., of FIG. 1D), a gateway, a server, a device providing cloud-computing services, a machine that forms part of a server farm, or a combination thereof, etc.).

For example, an operation 6044 may include an operation 6046 of requesting at least one antenna assembly configuration parameter from the at least one remote node. For instance, at least one portable wireless node (e.g., a portable wireless node 1002P, such as a tablet computer) may request (e.g., signal a prospective petition for) at least one antenna assembly configuration parameter 1070 (e.g., at least one variable impacting functionality of an antenna assembly or electromagnetic radiation emanating therefrom or collecting thereby, at least one mechanism affecting antenna assembly performance, at least one value applied to an antenna assembly control or data input, at least one boundary or guideline for how electromagnetic fields are to interact with an adjustable antenna assembly, at least one description of how to manipulate signals being forwarded to or accepted from an antenna assembly, at least one indication of a direction to point an antenna beam, at least one indication of a pattern in which to form an antenna beam, one or more phase delays, meta-material antenna control signal values, phased-array antenna operational inputs, antenna element or junction selection indicators, or a combination thereof, etc.) from at least one remote node 438 (e.g., an internet node 1016 (e.g., of FIG. 1D) supporting a wireless signal enhancement cloud-based program).

For example, an operation 504 may include an operation 6048 of retrieving at least one indication of the at least one direction from at least one local storage. For instance, at least one portable wireless node (e.g., a portable wireless node 1002P, such as a HTC One smart phone) may retrieve (e.g., acquire, read, extract, load, or a combination thereof, etc.) at least one indication 436 (e.g., a description, a designation, an expression, a representation, an indirect identification, a direct identification, a reference, a code providing a linkage to, a signal, a value, or a combination thereof, etc.) of at least one direction 412 (e.g., a vector having an origin at a device) from at least one local (e.g., integrated into, soldered onto, inserted in, physically coupled to, present within a housing of, or a combination thereof, etc. of a device) storage 440 (e.g., hardware capable of saving data, non-transitory media such as memory, physical component retaining bits, a processor register, a cache memory, RAM, flash memory, or a combination thereof, etc.).

For example, an operation 6048 may include an operation 6050 of retrieving at least one antenna control value for at least one meta-material antenna from at least one antenna configuration data structure. For instance, at least one portable wireless node (e.g., a portable wireless node 1002P, such as an Apple iPhone) may retrieve (e.g., extract) at least one antenna control value 442 (e.g., a numeral, a voltage level, a signal that sets a resonant frequency, or a combination thereof, etc.) for at least one meta-material antenna 1006MM (e.g., a surface scattering antenna, an antenna assembly including at least one meta-material, a component that emanates or collects electromagnetic radiation at different magnitudes at different places on a surface thereof, or a combination thereof, etc.) from at least one antenna configuration data structure 1008 (e.g., a database of conditions 1072 with associated antenna assembly configuration parameters 1070 (e.g., of FIG. 1E) and vice versa, a table or spreadsheet having one or more conditions that are associated with at least one antenna assembly configuration parameter, an structured query language (SQL) database linking physical states—such as spatial locations and orientation positions—with operational instructions for establishing beams with an antenna assembly, an associative data structure having respective global positioning system (GPS) coordinates and respective phase shifts, or a combination thereof, etc.).

For example, an operation 504 may include an operation 6051 of verifying at least one condition-configuration parameter association received from a wireless node. For instance, at least one portable wireless node (e.g., a portable wireless node 1002P, such as an Apple phablet-sized communication or entertainment device) may verify (e.g., check, confirm, test and review results, transmit or receive using and compare with other configuration parameter options, or a combination thereof, etc.—such as to ensure that another device is not sending out poor or incorrect configuration parameters inadvertently or to reserve superior or correct communication avenues for itself—alternatively, a device may send out spoofed associations to other devices to conceal or falsify its actual configuration parameters to thereby increase a likelihood that its throughput is effectively prioritized via potentially-reduced interference levels) at least one condition-configuration parameter association (e.g., a condition 1072 linked to an antenna assembly configuration parameter 1070; at least a portion of an antenna configuration data structure 1008, such as a structured query language (SQL) database linking physical states—such as spatial locations and orientation positions—with operational instructions for establishing beams with at least one antenna assembly; global positioning system (GPS) coordinates with respective phase shifts; at least one entry of an antenna configuration data structure; or a combination thereof, etc.) received (e.g., accepted, decoded, obtained from or via at least one electromagnetic signal, taken into possession wirelessly, routed at least partially via at least one antenna element, or a combination thereof, etc.) from a wireless node (e.g., another portable wireless node 1002P*, a fixed wireless node 1002F, a relay device or a repeater or an extender, or a combination thereof, etc.).

For example, an operation 504 may include an operation 6052 of obtaining at least one resonant frequency adjustor value for at least one antenna assembly. For instance, at least one portable wireless node (e.g., a portable wireless node 1002P, such as a smart phone) may obtain (e.g., receive) at least one resonant frequency adjustor value 444 (e.g., a number or numerical range, a current, a voltage level, a representation of control input to set a resonant frequency of at least one position on a surface scattering antenna, a matrix or process to establish one or more resonant frequencies of a meta-material antenna—such as for a resonant frequency adjustor 1080 of a meta-material antenna element 1078 thereof (e.g., of FIG. 1C), a setting to control at least a portion of at least one tuner for a meta-material antenna, or a combination thereof, etc.) for at least one antenna assembly 1006 (e.g., at least one antenna with one or more radiating elements, at least one meta-material antenna 1006MM, or a combination thereof, etc.).

For example, an operation 504 may include an operation 6054 of obtaining the at least one direction to aim the at least one beam based at least partially on at least one current spatial location of the portable wireless node. For instance, at least one portable wireless node (e.g., a portable wireless node 1002P, such as a tablet computer) may obtain (e.g., determine) at least one direction 412 (e.g., an identified reception angle with respect to or away from a given portion or part of a device) to aim (e.g., attempt to point) at least one beam 1028 (e.g., directed antenna signal interaction) based at least partially on at least one current (e.g., present, actual after a previous change, existing, most-recently determined, or a combination thereof, etc.) spatial location 1072SL (e.g., geographical/geospatial position, elevation position, floor level, room identification, one or more satellite positioning system (SPS) coordinates, distance from known object, height, address, or a combination thereof, etc.) of a portable wireless node 1002P (e.g., a tablet computer).

For example, an operation 6054 may include an operation 6056 of obtaining the at least one direction based at least partially on one or more satellite positioning system (SPS) coordinates. For instance, at least one portable wireless node (e.g., a portable wireless node 1002P, such as a Samsung phablet) may obtain (e.g., retrieve) at least one direction 412 (e.g., number of degrees or radians with respect to one or more axes) based at least partially on one or more satellite positioning system (SPS) coordinates (e.g., global positioning system (GPS) coordinates, Galileo coordinates, GLONASS coordinates, or a combination thereof, etc.).

FIG. 6D illustrates a flow diagram 600D having any one or more of example operations 6060-6078. For example, an operation 504 may include an operation 6060 of obtaining the at least one direction based at least partially on probing. For instance, at least one portable wireless node (e.g., a portable wireless node 1002P, such as a Lenovo convertible tablet-laptop) may obtain (e.g., ascertain) at least one direction 412 (e.g., a vector away from a device or a trajectory) based at least partially on probing (e.g., investigating, searching, questing, examining, exploring, or a combination thereof, etc.).

For example, an operation 6060 may include an operation 6062 of obtaining the at least one direction based at least partially on passive probing. For instance, at least one portable wireless node (e.g., a portable wireless node 1002P, such as an Apple iPad) may obtain (e.g., determine) at least one direction 412 (e.g., an identified reception bearing) based at least partially on passive (e.g., receptive, one or more acts of receiving signals, inactive, or a combination thereof, etc.) probing (e.g., exploring).

For example, an operation 6060 may include an operation 6064 of obtaining the at least one direction based at least partially on active probing. For instance, at least one portable wireless node (e.g., a portable wireless node 1002P, such as a smart phone) may obtain (e.g., calculate) at least one direction 412 (e.g., a determined transmission trajectory) based at least partially on active (e.g., transmissive, one or more acts of transmitting signals (along with analyzing confirmations or acknowledgments), active, or a combination thereof, etc.) probing (e.g., investigating).

For example, an operation 504 may include an operation 6066 of obtaining the at least one direction based at least partially on experimentation. For instance, at least one portable wireless node (e.g., a portable wireless node 1002P, such as a Nokia tablet) may obtain (e.g., acquire) at least one direction 412 (e.g., vector away from device) based at least partially on experimentation (e.g., testing, procedure to determine an unknown, investigation, research, trial transmission, tentative reception, or a combination thereof, etc.).

For example, an operation 6066 may include an operation 6068 of obtaining the at least one direction based at least partially on trial and error with at least one of one or more emanations or one or more receptions. For instance, at least one portable wireless node (e.g., a portable wireless node 1002P, such as a tablet computer) may obtain (e.g., determine) at least one direction 412 (e.g., degrees away from a cardinal direction) based at least partially on trial and error (e.g., sending out one or more transmissions and analyzing one or more responses (if any), processing—such as demodulating or decoding—received electromagnetic radiation to attempt to detect information content, evaluating one or more signal quality indicators, or a combination thereof, etc.) with at least one of one or more emanations (e.g., transmissions, sending of radio frequency (RF) signals, exciting electrons of an antenna, propagate electromagnetic radiation, or a combination thereof, etc.) or one or more receptions (e.g., receipts of signals, demodulation of electromagnetic effects on an antenna, taking data into possession wirelessly, or a combination thereof, etc.).

For example, an operation 6066 may include an operation 6070 of obtaining the at least one direction based at least partially on transmission of multiple beams having multiple respective indicators. For instance, at least one portable wireless node (e.g., a portable wireless node 1002P, such as an HP tablet computer) may obtain (e.g., ascertain) at least one direction 412 (e.g., a location to point an antenna beam) based at least partially on transmission (e.g., emanation from an emitter or antenna or element thereof, sending out electromagnetic radiation, sending out radio frequency (RF) signals, or a combination thereof, etc.) of multiple beams 1028 (e.g., focused wireless communication) having multiple respective indicators 450 (e.g., designation, expression, alphanumeric identifier, indirect identification, direct identification, modulation difference, reference, code, value, or a combination thereof, etc.).

For example, an operation 6070 may include an operation 6072 of obtaining the at least one direction based at least partially on at least one reception of at least one beam of the multiple beams as reported by the counterpart wireless node, the at least one reception including at least one indicator of the multiple respective indicators. For instance, at least one portable wireless node (e.g., a portable wireless node 1002P, such as an Apple iPad) may obtain (e.g., divine) at least one direction 412 (e.g., angle to aim a beam using one or more corresponding antenna assembly configuration parameters) based at least partially on at least one reception 452 (e.g., receipt of signals, demodulation of electromagnetic effects on an antenna, taking data into possession wirelessly, or a combination thereof, etc.) of at least one beam 1082 (e.g., non-omnidirectional wireless communication) of multiple beams 1028 as reported by (e.g., acknowledged by, confirmed by, identified via a message received from, or a combination thereof, etc.) a counterpart wireless node 1002C (e.g., a Linksys Wi-Fi access point), at least one reception 452 (e.g., accepting or processing of a signal originating externally, such as from a portable wireless node) including at least one indicator 450 (e.g., identifying code) of multiple respective indicators 450.

For example, an operation 6066 may include an operation 6074 of obtaining the at least one direction based at least partially on at least one of sweeping one or more beam transmissions along a first path or slicing one or more beam transmissions along a second path. For instance, at least one portable wireless node (e.g., a portable wireless node 1002P, such as a Samsung Galaxy S 6 smart phone) may obtain (e.g., ascertain) at least one direction 412 (e.g., location to aim an antenna beam) based at least partially on at least one of sweeping (e.g., moving, gliding, passing over with smooth movement in an arc, shifting in steps, or a combination thereof, etc.) one or more beam transmissions (e.g., emanation, transference, engagement, sending out, or a combination thereof, etc. of at least one beam) along a first path (e.g., horizontally, left-to-right or vice versa, along a horizon, along an azimuth angle, or a combination thereof, etc.) or slicing (e.g., moving, gliding, passing over with smooth movement in an arc, shifting in steps, or a combination thereof, etc.) one or more beam transmissions along a second path (e.g., vertically, high-to-low or vice versa, up or down, along an angle of elevation, or a combination thereof, etc.).

For example, an operation 6074 may include an operation 6076 of obtaining the at least one direction based at least partially on sweeping one or more beam transmissions along the first path and slicing one or more beam transmissions along the second path to locate a coverage zone for the counterpart wireless node. For instance, at least one portable wireless node (e.g., a portable wireless node 1002P, such as a smart phone) may obtain (e.g., determine) at least one direction 412 (e.g., bearing to place a beam with one or more corresponding antenna assembly configuration parameters) based at least partially on sweeping (e.g., moving, gliding, passing over with smooth movement in an arc, shifting in steps, or a combination thereof, etc.) beam transmissions (e.g., emanation, transference, engagement, sending out, or a combination thereof, etc. of at least one beam) along a first path (e.g., horizontally, left-to-right or vice versa, along a horizon, along an azimuth angle, or a combination thereof, etc.) and slicing (e.g., moving, gliding, passing over with smooth movement in an arc, shifting in steps, or a combination thereof, etc.) beam transmissions along a second path (e.g., vertically, high-to-low or vice versa, up or down, along an angle of elevation, or a combination thereof, etc.) to locate a coverage zone 454 (e.g., line, area, volume, space, or a combination thereof, etc. at which a beam may be directed or targeted to likely enable wireless communication) for a counterpart wireless node 1002C (e.g., a fixed wireless node 1002F such as a base station).

For example, an operation 6066 may include an operation 6078 of obtaining the at least one direction based at least partially on beam production coordination to connect with the counterpart wireless node. For instance, at least one portable wireless node (e.g., a portable wireless node 1002P, such as a General Dynamics unmanned aerial vehicle (UAV)) may obtain (e.g., decide upon) at least one direction 412 (e.g., trajectory or bearing) based at least partially on a beam 1028 (e.g., targeted transmission or reception spread for radio frequency (RF) signaling) production coordination (e.g., jointly creating, engaging in concert, planned interactive generation, each attempting to cover the other with a beam, cross-targeting coverage, or a combination thereof, etc.) to connect (e.g., enable simultaneous communication, facilitate two-way signaling, link together, wirelessly interface, or a combination thereof, etc.) with a counterpart wireless node 1002C (e.g., another portable wireless node 1002P* (not explicitly shown)).

FIG. 6E illustrates a flow diagram 600E having any one or more of example operations 6080-6096. For example, an operation 506 may include an operation 6080 of obtaining at least one different orientation position for the portable wireless node. For instance, at least one portable wireless node (e.g., a portable wireless node 1002P, such as a smart phone) may obtain (e.g., acquire) at least one different orientation position 1072DOP (e.g., a direction that may be faced toward or pointed to, a vector in space—such as a normal to a face or an edge of a device, an Euler value, a roll or pitch or yaw value, a value representing a tilt, a rotational position, an angle of inclination or declination, an equation defining a geometric object—such as a plane—having a determinable relationship to a position of a mobile device—such as lying within or being parallel thereto, or a combination thereof, etc. that differs or varies from or deviates from a current or previous orientation position) for a portable wireless node 1002P (e.g., a smart phone).

For example, an operation 6080 may include an operation 6082 of obtaining the at least one different orientation position for a current spatial location of the portable wireless node. For instance, at least one portable wireless node (e.g., a portable wireless node 1002P, such as a wireless communication component coupled to a vehicle) may obtain (e.g., determine) at least one different orientation position 1072DOP (e.g., at least one different Euler value) for a current (e.g., present, actual after a previous change, existing, most-recently measured, or a combination thereof, etc.) spatial location 1072SL (e.g., geographical/geospatial position, elevation position, floor level, room identification, one or more satellite positioning system (SPS) coordinates, distance from known object, height, address, or a combination thereof, etc.) of a portable wireless node 1002P (e.g., a wireless communication component coupled to a vehicle).

For example, an operation 6080 may include an operation 6084 of obtaining the at least one different orientation position for the portable wireless node using at least one antenna configuration data structure. For instance, at least one portable wireless node (e.g., a portable wireless node 1002P, such as a tablet computer) may obtain (e.g., retrieve) at least one different orientation position 1072DOP (e.g., a different rotational position such as pointing 45 degrees east of north instead of 15 degrees west of north) for a portable wireless node 1002P (e.g., a tablet computer) using at least one antenna configuration data structure 1008 (e.g., a database of conditions 1072 with associated antenna assembly configuration parameters 1070 (e.g., of FIG. 1E) and vice versa, a table or spreadsheet having one or more conditions that are associated with at least one antenna assembly configuration parameter, an structured query language (SQL) database linking physical states—such as spatial locations and orientation positions—with operational instructions for establishing beams with an antenna assembly, an associative data structure having respective global positioning system (GPS) coordinates and respective phase shifts, or a combination thereof, etc.).

For example, an operation 6080 may include an operation 6086 of obtaining the at least one different orientation position for the portable wireless node via at least one communication with at least one remote node. For instance, at least one portable wireless node (e.g., a portable wireless node 1002P, such as a Motorola Droid phone) may obtain (e.g., receive) at least one different orientation position 1072DOP (e.g., a different roll or pitch or yaw value) for a portable wireless node 1002P (e.g., a Motorola Droid phone) via at least one communication 434 (e.g., transmission, reception, exchange of packets, broadcasting, delivery of data, or a combination thereof, etc.) with at least one remote node 438 (e.g., a telecommunications node 1014 (e.g., of FIG. 1H), an internet node 1016 (e.g., of FIG. 1D), a gateway, a server, a device providing cloud-computing services, a machine that forms part of a server farm, or a combination thereof, etc.).

For example, an operation 6080 may include an operation 6088 of obtaining the at least one different orientation position based at least partially on at least one indicator of signal quality. For instance, at least one portable wireless node (e.g., a portable wireless node 1002P, such as a smart phone) may obtain (e.g., ascertain) at least one different orientation position 1072DOP based at least partially on at least one indicator 456 (e.g., designation, expression, alphanumeric identifier, indirect identification, direct identification, modulation difference, reference, code, average value, peak value, or a combination thereof, etc.) of signal quality 428 (e.g., received signal strength indicator (RSSI), signal-to-noise ratio (SNR), bit error rate (BER), latency, average or peak bandwidth, transmission power, or a combination thereof, etc.).

For example, an operation 6088 may include an operation 6090 of obtaining the at least one different orientation position based at least partially on at least one indicator of signal to noise ratio. For instance, at least one portable wireless node (e.g., a portable wireless node 1002P, such as an Apple iPhone) may obtain (e.g., determine) at least one different orientation position 1072DOP (e.g., a different angle of inclination or declination) based at least partially on at least one indicator 456 (e.g., average computed value) of signal to noise ratio (SNR) (e.g., value reflecting a comparison of signal level to noise level, ratio of desired signal power to background signal power, number of decibels, or a combination thereof, etc.).

For example, an operation 6088 may include an operation 6092 of obtaining the at least one different orientation position based at least partially on at least one indicator of current signal quality. For instance, at least one portable wireless node (e.g., a portable wireless node 1002P, such as a tablet computer) may obtain (e.g., procure) at least one different orientation position 1072DOP (e.g., a different Euler value) based at least partially on at least one indicator 456 (e.g., description or identification) of current signal quality 428C (e.g., received signal strength indicator (RSSI), signal-to-noise ratio (SNR), bit error rate (BER), latency, average or peak bandwidth, transmission power, or a combination thereof, etc. that is e.g., from the present, an actual value after a change from a previous value, existing, most-recently measured, or a combination thereof, etc.).

For example, an operation 6088 may include an operation 6094 of obtaining the at least one different orientation position based at least partially on at least one indicator of signal quality stored in association with the at least one different orientation position. For instance, at least one portable wireless node (e.g., a portable wireless node 1002P, such as a Nexus tablet computer) may obtain (e.g., retrieve) at least one different orientation position 1072DOP (e.g., a different direction to rotate a horizontally-disposed tablet that is resting on a table) based at least partially on at least one indicator 456 (e.g., assigned category or range) of signal quality 428S (e.g., received signal strength indicator (RSSI), signal-to-noise ratio (SNR), bit error rate (BER), latency, average or peak bandwidth, transmission power, or a combination thereof, etc. that is) stored (e.g., retained, accessible from being, saved, or a combination thereof, etc.) in association with (e.g., in correspondence to, in linkage with, in relation to, that pertains to, that is matched with, that is mated to, or a combination thereof, etc.) at least one different orientation position 1072DOP.

For example, an operation 6094 may include an operation 6096 of obtaining the at least one different orientation position based at least partially on at least one analysis including (i) the at least one indicator of signal quality stored in association with the at least one different orientation position and (ii) at least one indicator of current signal quality. For instance, at least one portable wireless node (e.g., a portable wireless node 1002P, such as a smart phone) may obtain (e.g., ascertain) at least one different orientation position 1072DOP (e.g., at least one Euler value, such as one or more degrees) based at least partially on at least one analysis (e.g., investigation of observations, evaluation of inputs, comparison, weighing of factors, or a combination thereof, etc.) including (i) at least one indicator 456 (e.g., average value) of signal quality 428S (e.g., received signal strength indicator (RSSI), signal-to-noise ratio (SNR), bit error rate (BER), latency, average or peak bandwidth, transmission power, or a combination thereof, etc. that is) stored (e.g., retained, accessible from being, saved, or a combination thereof, etc.) in association with (e.g., in correspondence to, in linkage with, in relation to, that pertains to, that is matched with, that is mated to, or a combination thereof, etc.) at least one different orientation position 1072DOP (e.g., in a data structure) and (ii) at least one indicator 456 (e.g., peak value) of current signal quality 428C (e.g., received signal strength indicator (RSSI), signal-to-noise ratio (SNR), bit error rate (BER), latency, average or peak bandwidth, transmission power, or a combination thereof, etc. that is e.g., from the present, an actual value after a change from a previous value, existing, most-recently measured, or a combination thereof, etc.) (e.g., a different orientation position may be retrieved from a data structure if it is associated with a superior stored signal quality indicator as compared to a current signal quality indicator).

FIG. 6F illustrates a flow diagram 600F having any one or more of example operations 6100-6118. For example, an operation 506 may include an operation 6100 of indicating to a user of the portable wireless node at least one different orientation position. For instance, at least one portable wireless node (e.g., a portable wireless node 1002P, such as a tablet computer) may indicate (e.g., show, tell, demonstrate, describe, signify, present, display, play aurally, or a combination thereof, etc.) to a user 458 (e.g., person, human, robot, actuator-equipped device, or a combination thereof, etc.) of a portable wireless node 1002P (e.g., a tablet computer) at least one different orientation position 1072DOP (e.g., a direction that may be faced toward or pointed to, a vector in space—such as a normal to a face or an edge of a device, an Euler value, a roll or pitch or yaw value, a value representing a tilt, a rotational position, an angle of inclination or declination, an equation defining a geometric object—such as a plane—having a determinable relationship to a position of a mobile device—such as lying within or being parallel thereto, or a combination thereof, etc. that differs or varies from or deviates from a current or previous orientation position).

For example, an operation 6100 may include an operation 6102 of indicating to the user the at least one different orientation position via one or more aural indications. For instance, at least one portable wireless node (e.g., a portable wireless node 1002P, such as a smart phone) may indicate (e.g., demonstrate) to a user 458 (e.g., person) at least one different orientation position 1072DOP (e.g., a different Euler matrix) via one or more aural indications 460 (e.g., sounds, words, beeps, noises, tones, audible air vibration, or a combination thereof, etc.).

For example, an operation 6102 may include an operation 6104 of indicating to the user the at least one different orientation position via one or more words describing how to move the portable wireless node. For instance, at least one portable wireless node (e.g., a portable wireless node 1002P, such as a Nexus smart phone) may indicate (e.g., tell) to a user 458 (e.g., human) at least one different orientation position 1072DOP (e.g., a different rotational position) via one or more words 462 (e.g., utterance, unit of speech, phrase, audible morpheme, or a combination thereof, etc.) describing (e.g., explaining, revealing, teaching, or a combination thereof, etc.) how to move (e.g., spin, twist in space, rotate, turn around an axis, revolve, or a combination thereof, etc.) a portable wireless node 1002P (e.g., a Nexus smart phone).

For example, an operation 6102 may include an operation 6106 of signifying to the user the at least one different orientation position via one or more sounds that change at least one characteristic as the portable wireless node is moved. For instance, at least one portable wireless node (e.g., a portable wireless node 1002P, such as a Samsung Galaxy Tab tablet computer) may signify (e.g., make known, express, connote, announce, convey, or a combination thereof, etc.) to a user 458 (e.g., a robot) at least one different orientation position 1072DOP (e.g., a different roll or pitch or yaw value) via one or more sounds 464 (e.g., beeps, musical tones, melody, ringing, or a combination thereof, etc.) that change (e.g., adjust, vary, alter, update, or a combination thereof, etc.) at least one characteristic 466 (e.g., frequency, loudness, intensity, cacophonous or discordant vs. sonorous or harmonious, pitch, quality, amplitude, wavelength, direction, speaker location production, or a combination thereof, etc.) as a portable wireless node 1002P (e.g., a Samsung Galaxy Tab tablet computer) is moved (e.g., spun, twisted in space, rotated, turned around an axis, revolved, or a combination thereof, etc.) (e.g., a sound may become more frequent or more harmonious as a device is rotated to a superior orientation position).

For example, an operation 6100 may include an operation 6108 of indicating to the user the at least one different orientation position via one or more visual indications. For instance, at least one portable wireless node (e.g., a portable wireless node 1002P, such as an Amazon phone) may indicate (e.g., show) to a user 458 (e.g., person) at least one different orientation position 1072DOP (e.g., a different direction to face a screen or point a top edge of a device) via one or more visual indications 468 (e.g., picture, image, arrow, moving image, video, graphics interchange format (GIF), sprite, screen display, light projection, hologram, model of device, illustration, or a combination thereof, etc.).

For example, an operation 6108 may include an operation 6110 of presenting to the user at least one directionality image representing how to position the portable wireless node to effect the at least one different orientation position. For instance, at least one portable wireless node (e.g., a portable wireless node 1002P, such as a phablet) may present (e.g., display, project, make visible, visually reveal, or a combination thereof, etc.) to a user 458 (e.g., a human) at least one directionality image 470 (e.g., an optical likeness, a two-dimensional or three-dimensional model, a semblance of a device, a picture, a visually-discernable representation, or a combination thereof, etc.) representing how (e.g., showing, modeling, signifying, demonstrating, or a combination thereof, etc. a movement to achieve a different orientation position, a placement realizing a different orientation position, or a combination thereof, etc.) to position (e.g., place, angle, incline, rotate, point, or a combination thereof, etc.) a portable wireless node 1002P to effect (e.g., bring about, make happen, accomplish, actuate, or a combination thereof, etc.) at least one different orientation position 1002DOP (e.g., a different Euler value).

For example, an operation 6110 may include an operation 6112 of changing the at least one directionality image as the portable wireless node is moved. For instance, at least one portable wireless node (e.g., a portable wireless node 1002P, such as a smart phone) may change (e.g., adjust, vary, alter, modify, update, or a combination thereof, etc.) at least one directionality image 470 (e.g., a visually-discernable model of a device) as a portable wireless node 1002P (e.g., a smart phone) is moved (e.g., spun, twisted in space, rotated, turned around an axis, revolved, or a combination thereof, etc.) (e.g., a model of a smart phone may be rotated on a screen with respect to a displayed reference line or plane to reflect real-world movements of the smart phone as a background changes from red to yellow to green as a different orientation position is achieved).

For example, an operation 6110 may include an operation 6114 of presenting to the user at least one directionality image showing how to rotate the portable wireless node with respect to at least one axis. For instance, at least one portable wireless node (e.g., a portable wireless node 1002P, such as a hand-held portable gaming/entertainment device) may present (e.g., display or project) to a user 458 (e.g., a person) at least one directionality image 470 (e.g., a two-dimensional representation) showing how (e.g., displaying a device representation with at least one superimposed arrow, playing a video in which a device model is shown rotating, or a combination thereof, etc.) to rotate (e.g., spin, tilt, revolve, angle, or a combination thereof, etc.) a portable wireless node 1002P (e.g., a hand-held portable gaming/entertainment device) with respect to at least one axis 472 (e.g., a point, line, or plane about which a body rotates; pivot; turning point; or a combination thereof; etc.).

For example, an operation 6114 may include an operation 6116 of presenting to the user at least one image model of the portable wireless node along with at least one graphical demonstration of how to rotate the portable wireless node. For instance, at least one portable wireless node (e.g., a portable wireless node 1002P, such as a Huawei smart phone) may present (e.g., display or project) to a user 458 (e.g., a human) at least one image model 474 (e.g., a two-dimensional or three-dimensional model, a semblance of a device, a visual replica, or a combination thereof, etc.) of a portable wireless node 1002P (e.g., a Huawei smart phone) along with at least one graphical demonstration 476 (e.g., playing a video in which a device model is shown rotating, showing a GIF in which a device replica spins, or a combination thereof, etc.) of how to rotate (e.g., spin, tilt, revolve, angle, or a combination thereof, etc.) a portable wireless node 1002P.

For example, an operation 6100 may include an operation 6118 of indicating to the user the at least one different orientation position via one or more haptic indications. For instance, at least one portable wireless node (e.g., a portable wireless node 1002P, such as a tablet computer) may indicate (e.g., signify) to a user 458 (e.g., person) at least one different orientation position 1072DOP (e.g., a different rotational position or inclination angle) via one or more haptic indications 478 (e.g., vibration, shake, pressure, force, quiver, oscillate, pulse, tremble, or a combination thereof, etc.) (e.g., a tablet computer may shake with decreasing intensity or frequency as a user rotates or inclines it towards a superior orientation position).

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to a human reader. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail herein, these logical operations/functions are not representations of abstract ideas, but rather are representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats-tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en [dot] wikipedia [dot] org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en [dot] wikipedia [dot] org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood by a human reader). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of logic, such as Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en [dot] wikipedia [dot] org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en [dot] wikipedia [dot] org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configurations, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en [dot] wikipedia [dot] org/wiki/Instructions_per_second (as of Jun. 5, 2012, 21:04 GMT). Thus, programs written in machine language—which may be tens of millions of machine language instructions long—are incomprehensible to most humans. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that useful, tangible, and concrete work is done. For example, as indicated above, such machine language—the compiled version of the higher-level language—functions as a technical specification which selects out hardware logic gates, specifies voltage levels, voltage transition timings, etc., such that the useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality of logic(s), or (d) virtually any combination of the foregoing. Indeed, any physical object which has a stable, measurable, and changeable state may be used to construct a machine based on the above technical description. Charles Babbage, for example, constructed the first mechanized computational apparatus out of wood, with the apparatus powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language should not be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, Verizon, AT&T, etc.), or (g) a wired/wireless services entity (e.g., Sprint, AT&T, Verizon, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although user 1034 is shown/described herein as a single illustrated figure, those skilled in the art will appreciate that user 1034 may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“laaS”), platform-as-a-service (“PaaS”), software-as-a-service (“SaaS”), and/or desktop-as-a-service (“DaaS”). As a non-exclusive example, laaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for portable wireless node orientation adjustment, the method being at least partially implemented by at least one device, the method comprising:
detecting a change in an orientation position of a portable wireless node; and
obtaining at least one direction to aim at least one beam toward a counterpart wireless node.

2.-56. (canceled)

57. A device for portable wireless node orientation adjustment, the device comprising:
circuitry for detecting a change in an orientation position of a portable wireless node; and
circuitry for obtaining at least one direction to aim at least one beam toward a counterpart wireless node.

58. The device of claim 57, wherein the circuitry for detecting a change in an orientation position of a portable wireless node comprises:
circuitry for detecting the change in the orientation position using at least one sensor.

59. (canceled)

60. The device of claim 57, wherein the circuitry for detecting a change in an orientation position of a portable wireless node comprises:
circuitry for detecting an amount of a change in the orientation position that comports with at least one threshold.

61. The device of claim 60, wherein the circuitry for detecting an amount of a change in the orientation position that comports with at least one threshold comprises:
circuitry for detecting at least a specified rotation measurement of the portable wireless node.

62. The device of claim 57, wherein the circuitry for obtaining at least one direction to aim at least one beam toward a counterpart wireless node comprises:
circuitry for obtaining the at least one direction to aim the at least one beam responsive at least partially to at least one orientation position change detection.

63. The device of claim 57, wherein the circuitry for obtaining at least one direction to aim at least one beam toward a counterpart wireless node comprises:
circuitry for determining the at least one direction to aim the at least one beam based at least partially on an employed direction and a detected change in the orientation position of the portable wireless node.

64. The device of claim 57, further comprising:
circuitry for aiming the at least one beam toward the counterpart wireless node in accordance with the at least one direction.

65. (canceled)

66. The device of claim 57, wherein the circuitry for detecting a change in an orientation position of a portable wireless node comprises:
circuitry for detecting the change in the orientation position responsive at least partially to expiration of an elapsed time.

67. The device of claim 57, wherein the circuitry for detecting a change in an orientation position of a portable wireless node comprises:
circuitry for detecting the change in the orientation position responsive at least partially to a detected translational movement distance.

68. The device of claim 57, wherein the circuitry for detecting a change in an orientation position of a portable wireless node comprises:
circuitry for detecting the change in the orientation position responsive at least partially to a detected change in at least one signal quality.

69. The device of claim 57, further comprising:
circuitry for detecting an extent of translational movement of the portable wireless node.

70. The device of claim 69, wherein the circuitry for detecting an extent of translational movement of the portable wireless node comprises:
circuitry for detecting a translational movement distance that comports with at least one linear distance threshold.

71. The device of claim 57, further comprising:
circuitry for detecting a change in signal quality for a communication including the portable wireless node.

72. The device of claim 71, wherein the circuitry for detecting a change in signal quality for a communication including the portable wireless node comprises:
circuitry for detecting if an extent of the change in the signal quality for the communication comports with at least one signal quality delta threshold.

73. (canceled)

74. The device of claim 57, wherein the circuitry for obtaining at least one direction to aim at least one beam toward a counterpart wireless node comprises:
circuitry for obtaining one or more antenna assembly configuration parameters corresponding to the at least one direction to aim the at least one beam toward the counterpart wireless node.

75. The device of claim 57, wherein the circuitry for obtaining at least one direction to aim at least one beam toward a counterpart wireless node comprises:
circuitry for obtaining one or more antenna assembly configuration parameters corresponding to a current orientation position of the portable wireless node.

76. The device of claim 57, wherein the circuitry for obtaining at least one direction to aim at least one beam toward a counterpart wireless node comprises:
circuitry for requesting at least one indication of the at least one direction from at least one remote node.

77. (canceled)

78. The device of claim 57, wherein the circuitry for obtaining at least one direction to aim at least one beam toward a counterpart wireless node comprises:
circuitry for retrieving at least one indication of the at least one direction from at least one local storage.

79. The device of claim 78, wherein the circuitry for retrieving at least one indication of the at least one direction from at least one local storage comprises:
circuitry for retrieving at least one antenna control value for at least one meta-material antenna from at least one antenna configuration data structure.

80. The device of claim 57, wherein the circuitry for obtaining at least one direction to aim at least one beam toward a counterpart wireless node comprises:
circuitry for verifying at least one condition-configuration parameter association received from a wireless node.

81. (canceled)

82. The device of claim 57, wherein the circuitry for obtaining at least one direction to aim at least one beam toward a counterpart wireless node comprises:
circuitry for obtaining the at least one direction to aim the at least one beam based at least partially on at least one current spatial location of the portable wireless node.

83. (canceled)

84. The device of claim 57, wherein the circuitry for obtaining at least one direction to aim at least one beam toward a counterpart wireless node comprises:
circuitry for obtaining the at least one direction based at least partially on probing.

85. (canceled)

86. (canceled)

87. The device of claim 57, wherein the circuitry for obtaining at least one direction to aim at least one beam toward a counterpart wireless node comprises:
circuitry for obtaining the at least one direction based at least partially on experimentation.

88. The device of claim 87, wherein the circuitry for obtaining the at least one direction based at least partially on experimentation comprises:
circuitry for obtaining the at least one direction based at least partially on trial and error with at least one of one or more emanations or one or more receptions.

89. The device of claim 87, wherein the circuitry for obtaining the at least one direction based at least partially on experimentation comprises:
circuitry for obtaining the at least one direction based at least partially on transmission of multiple beams having multiple respective indicators.

90. (canceled)

91. The device of claim 87, wherein the circuitry for obtaining the at least one direction based at least partially on experimentation comprises:
circuitry for obtaining the at least one direction based at least partially on at least one of sweeping one or more beam transmissions along a first path or slicing one or more beam transmissions along a second path.

92. (canceled)

93. The device of claim 87, wherein the circuitry for obtaining the at least one direction based at least partially on experimentation comprises:
circuitry for obtaining the at least one direction based at least partially on beam production coordination to connect with the counterpart wireless node.

94. The device of claim 57, further comprising:
circuitry for obtaining at least one different orientation position for the portable wireless node.

95. The device of claim 94, wherein the circuitry for obtaining at least one different orientation position for the portable wireless node comprises:
circuitry for obtaining the at least one different orientation position for a current spatial location of the portable wireless node.

96. The device of claim 94, wherein the circuitry for obtaining at least one different orientation position for the portable wireless node comprises:
circuitry for obtaining the at least one different orientation position for the portable wireless node using at least one antenna configuration data structure.

97. (canceled)

98. The device of claim 94, wherein the circuitry for obtaining at least one different orientation position for the portable wireless node comprises:
circuitry for obtaining the at least one different orientation position based at least partially on at least one indicator of signal quality.

99. (canceled)

100. (canceled)

101. The device of claim 98, wherein the circuitry for obtaining the at least one different orientation position based at least partially on at least one indicator of signal quality comprises:
circuitry for obtaining the at least one different orientation position based at least partially on at least one indicator of signal quality stored in association with the at least one different orientation position.

102. (canceled)

103. The device of claim 57, further comprising:
circuitry for indicating to a user of the portable wireless node at least one different orientation position.

104. The device of claim 103, wherein the circuitry for indicating to a user of the portable wireless node at least one different orientation position comprises:
circuitry for indicating to the user the at least one different orientation position via one or more aural indications.

105. (canceled)

106. The device of claim 104, wherein the circuitry for indicating to the user the at least one different orientation position via one or more aural indications comprises:
circuitry for signifying to the user the at least one different orientation position via one or more sounds that change at least one characteristic as the portable wireless node is moved.

107. The device of claim 103, wherein the circuitry for indicating to a user of the portable wireless node at least one different orientation position comprises:
circuitry for indicating to the user the at least one different orientation position via one or more visual indications.

108. The device of claim 107, wherein the circuitry for indicating to the user the at least one different orientation position via one or more visual indications comprises:
circuitry for presenting to the user at least one directionality image representing how to position the portable wireless node to effect the at least one different orientation position.

109.-111. (canceled)

112. The device of claim 103, wherein the circuitry for indicating to a user of the portable wireless node at least one different orientation position comprises:
circuitry for indicating to the user the at least one different orientation position via one or more haptic indications.

113. An apparatus for portable wireless node orientation adjustment, the apparatus comprising:
means for detecting a change in an orientation position of a portable wireless node; and
means for obtaining at least one direction to aim at least one beam toward a counterpart wireless node.

114.-168. (canceled)
